(19) United States
(12) Patent Application Publication
(10) Pub. No.: US 2019/0330727 A1
(43) Pub. Date: Oct. 31, 2019

(54) METHODS OF PREPARING ALUMINUM ALLOY PRODUCTS FOR BONDING

(71) Applicant: ARCONIC INC., Pittsburgh, PA (US)

(72) Inventors: June M. Epp, Pittsburgh, PA (US); Gavin F. Wyatt-Mair, Lafayette, CA (US); Ali Unal, Export, PA (US)

(21) Appl. No.: 16/505,421

(22) Filed: Jul. 8, 2019

Related U.S. Application Data
(63) Continuation of application No. PCT/US2018/013371, filed on Jan. 11, 2018.
(60) Provisional application No. 62/445,153, filed on Jan. 11, 2017.

(51) Int. Cl. C22F 1/047; C22C 21/06; B32B 15/01; C21D 1/42; B32B 7/12

(52) U.S. Cl. CPC C22F 1/047; C22C 21/06; C21D 2221/00; C21D 1/42; B32B 7/12; B32B 15/016

(57) ABSTRACT

Disclosed methods include a preparing step, including induction heating at least a portion of an aluminum alloy (AA) product and optionally quenching the induction heated AA product. After the preparing step, the methods include one of a contacting step and a bonding step. The contacting step includes contacting the at least a portion of the AA product with one of: a deoxidizing agent and a functionalization solution, where between the preparing and contacting steps the method is absent of any surface oxide treating steps of the AA product. The bonding step includes bonding the at least a portion of the AA product with a second material, thereby creating an as-bonded AA product, where between the preparing and bonding steps the method is absent of any surface oxide treating steps of the AA product. The methods may be employed to produce AA products for structural adhesive bonding applications.

### CROSS-REFERENCE TO RELATED APPLICATION

This application is a continuation of International Patent Application No. PCT/US2018/013371, filed Jan. 11, 2018, which claims benefit of priority of U.S. Provisional Patent Application No. 62/445,153, filed Jan. 11, 2017, each of which is incorporated herein by reference in its entirety.

### BACKGROUND

Aluminum alloy products are used in a number of industries, including the automotive industry. In some instances, aluminum alloys need to be adhesively structurally bonded to other materials.

### SUMMARY

In a known process, exemplified by U.S. Patent Publication No. 2016/0319440, which is incorporated herein by reference in its entirety, heat treated aluminum alloy product feedstock (e.g., sheet products) may be treated using a known method. The known method of U.S. Patent Publication No. 2016/0319440 includes the step of a) applying a cleaner to a surface of an aluminum alloy sheet or coil. The method of U.S. Patent Publication No. 2016/0319440 includes the step of b) etching the surface of the aluminum sheet or the coil with an acidic solution. The method of U.S. Patent Publication No. 2016/0319440 includes the step of c) rinsing the surface of the aluminum sheet or the coil with de-ionized water. The method of U.S. Patent Publication No. 2016/0319440 includes the step of d) applying to the surface of the aluminum sheet or the coil a solution of an acidic organophosphorus compound. The method of U.S. Patent Publication No. 2016/0319440 includes the step of e) rinsing the surface of the aluminum sheet or the coil with deionized water. The method of U.S. Patent Publication No. 2016/0319440 includes the step of f) drying the surface of the aluminum sheet or the coil.

As described below, including by way of examples, the systems and methods disclosed herein provide for completing the known method of U.S. Patent Publication No. 2016/0319440 in the absence of at least steps a) and b), above.

In an embodiment, a method includes the step of (a) preparing an aluminum alloy product for surface deoxidization. In the embodiment, the preparing step (a) includes induction heating, with an induction heater, at least a portion of the aluminum alloy product, where the induction heating comprises annealing or solution heat treating the aluminum alloy product. In the embodiment, the preparing step (a) optionally includes quenching the induction heated aluminum alloy product.

In the embodiment, after the preparing step (a), the method includes the step of (b) contacting the at least a portion of the aluminum alloy product with a deoxidizing agent.

In the embodiment, between the preparing (a) and contacting (b) steps the method is absent of any surface oxide treating steps of the aluminum alloy product.

In one embodiment, between the preparing step (a) and the contacting step (b) the method is absent of any surface cleaning and etching treatments.

In one embodiment, after the contacting step (b) the method is absent of any surface cleaning and etching treatments.

In one embodiment, the method includes cleaning the at least a portion of the aluminum alloy product between the preparing step (a) and the contacting step (b).

In one embodiment, the method includes bonding the at least a portion of the aluminum alloy product with a second material after the contacting step (b), thereby creating an as-bonded aluminum alloy product. In the embodiment, the at least a portion of the aluminum alloy product includes a first portion of the aluminum alloy product, and the second material includes at least a second portion of the aluminum alloy product. In the embodiment, when in a form of a single-lap-joint specimen having an aluminum metal-to-aluminum metal joint overlap of 0.5 inches, the as-bonded aluminum alloy product achieves completion of 45 stress durability test (SDT) cycles according to ASTM D1002 (10).

In one embodiment, a residual shear strength of the single-lap-joint specimen after completing the 45 SDT cycles is at least 80% of an initial shear strength of the single-lap-joint specimen prior to commencing the 45 SDT cycles. In another embodiment, the residual shear strength of the single-lap-joint specimen after completing the 45 SDT cycles is at least 85% of the initial shear strength of the single-lap-joint specimen prior to commencing the 45 SDT cycles. In yet another embodiment, the residual shear strength of the single-lap-joint specimen after completing the 45 SDT cycles is at least 90% of the initial shear strength of the single-lap-joint specimen prior to commencing the 45 SDT cycles.

In one embodiment, the aluminum alloy product is a 5xxx aluminum alloy product. In one embodiment, the induction heating includes providing an O-temper 5xxx aluminum alloy product. In one embodiment, the aluminum alloy product is a 6xxx aluminum alloy product. In one embodiment, the induction heating comprises providing a T4-temper or T4-temper variants in 6xxx aluminum alloy product.

In one embodiment, the at least a portion of the aluminum alloy product realizes a residence time of not greater than 0.4 minutes of induction heating. In another embodiment, the at least a portion of the aluminum alloy product realizes a residence time of from 0.2 to 0.4 minutes of induction heating. In one embodiment, the at least a portion of the aluminum alloy product realizes a peak metal temperature of from 900 to 1040° F. during the induction heating. In another embodiment, the at least a portion of the aluminum alloy product realizes a peak metal temperature of from 900 to less than 1040° F. during the induction heating. In yet another embodiment, the at least a portion of the aluminum alloy product realizes a peak metal temperature of from 930 to 1030° F. during the induction heating. In still another embodiment, the at least a portion of the aluminum alloy product realizes a peak metal temperature of from 950 to 1020° F. during the induction heating. In yet another embodiment, the at least a portion of the aluminum alloy product realizes a peak metal temperature of from 970 to 1000° F. during the induction heating.

In one embodiment, the aluminum alloy product is a sheet product. In the embodiment, the sheet product may have a gauge of from 0.5 to 6 mm after the induction heating and the optional quenching. In another embodiment, the aluminum alloy product is an extruded product. In yet another embodiment, the aluminum alloy product is a forged product. In the embodiment, the forged product may be a symmetric forging or a shaped forging. In still another embodiment, the aluminum alloy product is a cast product. In the embodiment, the cast product may be a symmetric casting or a shaped casting. In yet another embodiment, the aluminum alloy product is an additively manufactured part.

In an embodiment, a method includes the step of (a) preparing an aluminum alloy product for treatment with a functionalization solution. In the embodiment, the preparing step (a) includes induction heating, with an induction heater, at least a portion of the aluminum alloy product, where the induction heating comprises annealing or solution heat treating the aluminum alloy product. In the embodiment, the preparing step (a) optionally includes quenching the induction heated aluminum alloy product.

In the embodiment, after the preparing step (a), the method includes the step of (b) contacting the at least a portion of the aluminum alloy product with the functionalization solution.

In the embodiment, between the preparing step (a) and the contacting step (b) the method is absent of any surface oxide treating steps of the aluminum alloy product.

In one embodiment, between the preparing step (a) and the contacting step (b) the method is absent of any surface cleaning and etching treatments.

In one embodiment, the functionalization solution comprises a phosphorus-containing organic acid.

In one embodiment, the contacting step (b) facilitates creating a functionalized aluminum alloy product. In the embodiment, the method includes bonding at least a portion of the as-functionalized aluminum alloy product with a second material after the contacting step (b), thereby creating an as-bonded aluminum alloy product. In the embodiment, the at least a portion of the aluminum alloy product includes a first portion of the aluminum alloy product, and the second material includes at least a second portion of the aluminum alloy product. In the embodiment, when in a form of a single-lap-joint specimen having an aluminum metal-to-aluminum metal joint overlap of 0.5 inches, the as-bonded aluminum alloy product achieves completion of 45 SDT cycles according to ASTM D1002 (10).

In one embodiment, a residual shear strength of the single-lap-joint specimen after completing the 45 SDT cycles is at least 80% of an initial shear strength of the single-lap-joint specimen prior to commencing the 45 SDT cycles. In another embodiment, the residual shear strength of the single-lap-joint specimen after completing the 45 SDT cycles is at least 85% of the initial shear strength of the single-lap-joint specimen prior to commencing the 45 SDT cycles. In yet another embodiment, the residual shear strength of the single-lap-joint specimen after completing the 45 SDT cycles is at least 90% of the initial shear strength of the single-lap-joint specimen prior to commencing the 45 SDT cycles.

In one embodiment, the aluminum alloy product is a 5xxx aluminum alloy product. In one embodiment, the induction heating includes providing an O-temper 5xxx aluminum alloy product. In one embodiment, the aluminum alloy product is a 6xxx aluminum alloy product. In one embodiment, the induction heating comprises providing a T4-temper or T4-temper variants of 6xxx aluminum alloy product.

In one embodiment, the at least a portion of the aluminum alloy product realizes a residence time of not greater than 0.4 minutes of induction heating. In another embodiment, the at least a portion of the aluminum alloy product realizes a residence time of from 0.2 to 0.4 minutes of induction heating. In one embodiment, the at least a portion of the aluminum alloy product realizes a peak metal temperature of from 900 to 1040° F. during the induction heating. In another embodiment, the at least a portion of the aluminum alloy product realizes a peak metal temperature of from 900 to less than 1040° F. during the induction heating. In yet another embodiment, the at least a portion of the aluminum alloy product realizes a peak metal temperature of from 930 to 1030° F. during the induction heating. In still another embodiment, the at least a portion of the aluminum alloy product realizes a peak metal temperature of from 950 to 1020° F. during the induction heating. In yet another embodiment, the at least a portion of the aluminum alloy product realizes a peak metal temperature of from 970 to 1000° F. during the induction heating.

In one embodiment, the aluminum alloy product is a sheet product. In the embodiment, the sheet product may have a gauge of from 0.5 to 6 mm after the induction heating and the optional quenching. In another embodiment, the aluminum alloy product is an extruded product. In yet another embodiment, the aluminum alloy product is a forged product. In the embodiment, the forged product may be a symmetric forging or a shaped forging. In still another embodiment, the aluminum alloy product is a cast product. In the embodiment, the cast product may be a symmetric casting or a shaped casting. In yet another embodiment, the aluminum alloy product is an additively manufactured part.

In an embodiment, a method includes the step of (a) preparing an aluminum alloy product for bonding. In the embodiment, the preparing step (a) includes induction heating, with an induction heater, at least a portion of the aluminum alloy product, where the induction heating comprises annealing or solution heat treating the aluminum alloy product. In the embodiment, the preparing step (a) optionally includes quenching the induction heated aluminum alloy product.

In the embodiment, the method includes the step of (b) bonding the at least a portion of the aluminum alloy product with a second material after the preparing step (a), thereby creating an as-bonded aluminum alloy product.

In the embodiment, the method is absent of any surface oxide treating steps of the aluminum alloy product between the preparing (a) and bonding (b) steps.

In one embodiment, after the preparing step (a) the method is absent of any surface cleaning and etching treatments.

In one embodiment, the method includes cleaning the at least a portion of the aluminum alloy product after the preparing step (a).

In one embodiment, the at least a portion of the aluminum alloy product includes a first portion of the aluminum alloy product, and the second material includes at least a second portion of the aluminum alloy product. In the embodiment, when in a form of a single-lap-joint specimen having an aluminum metal-to-aluminum metal joint overlap of 0.5 inches, the as-bonded aluminum alloy product achieves completion of 45 SDT cycles according to ASTM D1002 (10).

In one embodiment, a residual shear strength of the single-lap-joint specimen after completing the 45 SDT cycles is at least 80% of an initial shear strength of the single-lap-joint specimen prior to commencing the 45 SDT cycles. In another embodiment, the residual shear strength of the single-lap-joint specimen after completing the 45 SDT cycles is at least 85% of the initial shear strength of the single-lap-joint specimen prior to commencing the 45 SDT cycles. In yet another embodiment, the residual shear strength of the single-lap-joint specimen after completing the 45 SDT cycles is at least 90% of the initial shear strength of the single-lap-joint specimen prior to commencing the 45 SDT cycles.

In one embodiment, the aluminum alloy product is a 5xxx aluminum alloy product. In one embodiment, the induction heating includes providing an O-temper 5xxx aluminum alloy product. In one embodiment, the aluminum alloy product is a 6xxx aluminum alloy product. In one embodiment, the induction heating comprises providing a T4-temper or T4-temper variants of 6xxx aluminum alloy product.

In one embodiment, the at least a portion of the aluminum alloy product realizes a residence time of not greater than 0.4 minutes of induction heating. In another embodiment, the at least a portion of the aluminum alloy product realizes a residence time of from 0.2 to 0.4 minutes of induction heating. In one embodiment, the at least a portion of the aluminum alloy product realizes a peak metal temperature of from 900 to 1040° F. during the induction heating. In another embodiment, the at least a portion of the aluminum alloy product realizes a peak metal temperature of from 900 to less than 1040° F. during the induction heating. In yet another embodiment, the at least a portion of the aluminum alloy product realizes a peak metal temperature of from 930 to 1030° F. during the induction heating. In still another embodiment, the at least a portion of the aluminum alloy product realizes a peak metal temperature of from 950 to 1020° F. during the induction heating. In yet another embodiment, the at least a portion of the aluminum alloy product realizes a peak metal temperature of from 970 to 1000° F. during the induction heating.

In one embodiment, the aluminum alloy product is a sheet product. In the embodiment, the sheet product may have a gauge of from 0.5 to 6 mm after the induction heating and the optional quenching. In another embodiment, the aluminum alloy product is an extruded product. In yet another embodiment, the aluminum alloy product is a forged product. In the embodiment, the forged product may be a symmetric forging or a shaped forging. In still another embodiment, the aluminum alloy product is a cast product. In the embodiment, the cast product may be a symmetric casting or a shaped casting. In yet another embodiment, the aluminum alloy product is an additively manufactured part.

The figures constitute a part of this specification and include illustrative embodiments of the present disclosure and illustrate various objects and features thereof. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on”.

### BRIEF DESCRIPTION OF THE DRAWINGS

FIG. 1 is a flow chart of an induction heat treatment method.

FIG. 2 is a schematic diagram of one embodiment of an apparatus that may be used to carry out the induction heat treatment method of FIG. 1.

FIG. 3 is a schematic diagram of another embodiment of an apparatus that may be used to carry out the induction heat treatment method of FIG. 1.

FIG. 4 is a graph of Mg2Si (volume percent) versus solution heat treatment temperature for induction heated, molten lead bath heated, and air furnace heating samples.

FIG. 5 is a flow chart of a prior art method for preparing an aluminum alloy product for bonding.

FIG. 6 is a schematic diagram of an aluminum alloy product.

FIG. 7 is a flow chart of a method for preparing an aluminum alloy product in accordance with one embodiment of the invention.

FIG. 8 is a flow chart of one embodiment of the preparing and contacting steps of FIG. 7.

FIG. 9A is a plot of X-ray photoelectron spectroscopy (XPS) analysis results for a surface oxide layer of an induction heat treated 6022-T4 aluminum alloy sheet product sample prepared in accordance with the method of FIGS. 7 and 8.

FIG. 9B is a plot of XPS analysis results for the surface oxide of a 6022-T4 aluminum alloy sheet product sample that was heat treated using a conventional Continuous heat treating furnace.

FIG. 10 is a flow chart of a method for preparing an aluminum alloy product in accordance with one embodiment of the invention.

FIG. 11 is a flow chart of one embodiment of the preparing and contacting steps of FIG. 10.

FIG. 12 is a flow chart of a method for preparing an aluminum alloy product in accordance with one embodiment of the invention.

FIG. 13 is a flow chart of one embodiment of the preparing and bonding steps of FIG. 12.

### DETAILED DESCRIPTION

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

Induction Heating of Aluminum Alloy Products

As used herein, the term “anneal” refers to a heating process that primarily causes recrystallization of the metal to occur. In some embodiments, anneal may further include dissolution of soluble constituent particles based, at least in part, on the size of the soluble constituent particles and the annealing temperature. In embodiments, temperatures used in annealing aluminum alloys range from about 600 to 900° F.

Also as used herein, the phrase “solution heat treatment” refers to a metallurgical process in which the metal is held at a high temperature so as to cause the secondary phase particles of the alloying elements to dissolve into solid solution. Temperatures used in solution heat treatment are generally higher than those used in annealing, and range up to about 1100° F. for aluminum alloys. This condition is then maintained by quenching of the metal for the purpose of strengthening the final product by controlled precipitation (aging).

As used herein, in an embodiment, the term “feedstock” refers to an aluminum alloy ingot cast using a non-continuous casting process such as direct chill casting. The feedstock employed in the practice of the present invention can be prepared by any casting technique known to those skilled in the art for casting an ingot. In some embodiments, the feedstock may have been optionally subjected to one or more of the following steps prior to heating: shearing, trimming, quenching, hot and/or cold rolling, and/or coiling. In some embodiments, the ingot is hot and/or cold rolled until the final predetermined gauge is reached to form a feedstock and then coiled to form a coiled feedstock.

In another embodiment, the term “feedstock” may refer to an aluminum alloy strip produced using continuously casting. In some embodiments, the feedstock is a non-ferrous alloy strip produced using a method described in U.S. Pat. Nos. 5,515,908; 6,672,368; and 7,125,612 each of which are assigned to the assignee of the present invention and incorporated by reference in its entirety.

As used herein, feedstock may be rolled in the form of a “strip” that may be of any suitable thickness, and is generally of sheet gauge (0.006 inch to 0.249 inch) or thin-plate gauge (0.250 inch to 0.400 inch), i.e., has a thickness in the range of 0.006 inch to 0.400 inch. In one embodiment, the strip has a thickness of at least 0.040 inch. In one embodiment, the strip has a thickness of no greater than 0.320 inch. In some embodiments, the strip has a thickness in the range of 0.04 to 0.2 inches. In some embodiments, the strip has a thickness in the range of 0.03 to 0.15 inch. In some embodiments, the strip has a thickness in the range of 0.02 to 0.30 inch. In some embodiments, the strip has a thickness in the range of 0.1 to 0.3 inches in thickness.

In some embodiments, the aluminum alloy strip has a width up to about 90 inches, depending on desired continued processing and the end use of the strip. In some embodiments, the aluminum alloy strip has a width up to about 80 inches, depending on desired continued processing and the end use of the strip. In some embodiments, the aluminum alloy strip has a width up to about 70 inches, depending on desired continued processing and the end use of the strip. In some embodiments, the aluminum alloy strip has a width up to about 60 inches, depending on desired continued processing and the end use of the strip. In some embodiments, the aluminum alloy strip has a width up to about 50 inches, depending on desired continued processing and the end use of the strip.

As used herein, the term “dissolution” refers to causing one or more constituents to enter into solid solution during solution heat treatment. As used herein, the amount of “dissolution” is determined based on the volume percent of soluble secondary phase particles in a heat-treated product. Thus, higher “dissolution” corresponds to a lower volume percent of soluble secondary phase particles in the heat-treated product and lower “dissolution” corresponds to a higher volume percent of soluble secondary phase particles in the heat-treated product.

As used herein, the term “temperature” or “heating temperature” may refer to an average temperature, a maximum temperature, or a minimum temperature. As used herein, the term “temperature” may refer to the temperature of the heated product and/or the temperature of the heating device—e.g., the temperature of the molten lead bath or the temperature of the air furnace.

As used herein, the phrase “6xxx series aluminum alloy” and the like means an aluminum alloy is a 6xxx series aluminum alloys registered with the Aluminum Association and unregistered variants of the same.

As used herein, “heating duration” and “residence time” mean the time elapsed between the start of heating an alloy and the start of quenching an alloy. In embodiments, the heating duration includes both the heating time and the hold time.

In an embodiment, the method comprises obtaining an ingot; wherein the ingot is a 6xxx series aluminum alloy; at least one of hot rolling or cold rolling the ingot to form a feedstock; induction heating the feedstock; and quenching the feedstock to form a heat-treated product having a T temper; and wherein the induction heating step is conducted at a sufficient heating temperature so that the heat-treated product has a volume percent of soluble secondary phase particles of less than 0.1%; wherein the sufficient heating temperature of the induction heating step is less than a sufficient heating temperature required to achieve a volume percent of soluble secondary phase particles of less than 0.1% in a comparative product; and wherein the comparative product has the same composition and is subjected to same method steps as the heat-treated product except the comparative product is heated using an air furnace instead of induction heating.

In one or more embodiments detailed herein, the sufficient heating temperature is 930 to 975 degrees F. In one or more embodiments detailed herein, the sufficient heating duration is 10 to 70 seconds. In one or more embodiments detailed herein, a sufficient heating temperature is 930 to 950 degrees F. In one or more embodiments detailed herein, the sufficient heating duration is 40 to 70 seconds.

In one or more embodiments detailed herein, the method further comprises, after the hot rolling or cold rolling step, coiling the feedstock. In one or more embodiments detailed herein, the method further comprises uncoiling the coiled feedstock before the induction heating step.

In one or more embodiments detailed herein, the temper is T4 temper. In one or more embodiments detailed herein, the obtaining step comprises casting the ingot using direct chill casting. In yet another embodiment, the 6xxx series aluminum alloy is a 6022 aluminum alloy.

In another embodiment, the method comprises obtaining a 6xxx series aluminum alloy ingot; at least one of hot rolling or cold rolling the ingot to form a feedstock; induction heating the feedstock; and quenching the feedstock to form a heat-treated product having a W or T4 temper; wherein the induction heating step is conducted at a sufficient heating temperature so that the heat-treated product has a volume percent of soluble secondary phase particles of less than 0.1%; wherein the sufficient heating temperature of the induction heating step is less than a sufficient heating temperature required to achieve a volume percent of soluble secondary phase particles of less than 0.1% in a comparative product; and wherein the comparative product has the same composition and is subjected to same method steps as the heat-treated product except the comparative product is heated using an lead bath instead of induction heating.

In one or more embodiments detailed herein, the sufficient heating temperature is 950 to 985 degrees F. In one or more embodiments detailed herein, a heating duration of the induction heating step is 10 to 70 seconds. In one or more embodiments detailed herein, the sufficient heating temperature is 960 to 985 degrees F. In one or more embodiments detailed herein, the sufficient heating duration is 40 to 70 seconds. In one or more embodiments detailed herein, after the hot rolling or cold rolling step, coiling the feedstock. In one or more embodiments detailed herein, the method further comprises uncoiling the coiled feedstock before the induction heating step. In one or more embodiments detailed herein, the temper is T4 temper. In one or more embodiments detailed herein, the obtaining step comprises casting the ingot using direct chill casting. In one or more embodiments detailed herein, the 6xxx series aluminum alloy is a 6022 aluminum alloy.

In an embodiment, the method comprises obtaining an ingot; wherein the ingot is a 6xxx series aluminum alloy; at least one of hot rolling or cold rolling the ingot to form a feedstock; induction heating the feedstock; and quenching the feedstock to form a heat-treated product having a T temper; and wherein the induction heating step is conducted at a sufficient heating temperature so that the heat-treated product has a volume percent of soluble secondary phase particles of less than 0.05%; wherein the sufficient heating temperature of the induction heating step is less than a sufficient heating temperature required to achieve a volume percent of soluble secondary phase particles of less than 0.05% in a comparative product; and wherein the comparative product has the same composition and is subjected to same method steps as the heat-treated product except the comparative product is heated using an air furnace instead of induction heating.

In an embodiment, the method comprises obtaining an ingot; wherein the ingot is a 6xxx series aluminum alloy; at least one of hot rolling or cold rolling the ingot to form a feedstock; induction heating the feedstock; and quenching the feedstock to form a heat-treated product having a T temper; and wherein the induction heating step is conducted at a sufficient heating temperature so that the heat-treated product has a volume percent of soluble secondary phase particles of less than 0.05%; wherein the sufficient heating temperature of the induction heating step is less than a sufficient heating temperature required to achieve a volume percent of soluble secondary phase particles of less than 0.05% in a comparative product; and wherein the comparative product has the same composition and is subjected to same method steps as the heat-treated product except the comparative product is heated using an lead bath instead of induction heating.

In one or more embodiments detailed herein, the method comprises obtaining a 6xxx series aluminum alloy ingot; at least one of hot rolling or cold rolling the ingot to form a feedstock; induction heating the feedstock; and quenching the feedstock to form a heat-treated product having a T4 temper; wherein the induction heating step is conducted at a sufficient heating temperature and a sufficient heating duration so that the heat-treated product has a volume percent of Mg2Si particles of less than 0.05%; and wherein the sufficient heating temperature is 930 to 975 degrees F. and the sufficient heating duration is 10 to 70 seconds.

As detailed herein, the inventors have found that induction heat treatment of ingot cast products at a lower temperature and/or lower duration compared to other heat treatment methods known in the art such as heat treatment in a molten lead bath or heat treatment in an air furnace results in a heat treated product having equal or improved dissolution of soluble secondary phase particles compared to the other heat treatment methods.

In one or more embodiments detailed herein, the present invention relates to a method of heat treating an aluminum alloy feedstock in an off-line or inline process. In one or more embodiments detailed herein, the present invention relates to a method of making aluminum alloy strip in an off-line process. In one or more embodiments detailed herein, the present invention relates to a method of heating a feedstock in an off-line process. In one or more embodiments detailed herein, the method is used to make aluminum alloy strip of T (heat-treated) temper having the desired properties by induction heating to a lower temperature and for a shorter duration than other heat treatment methods such as heating in a lead bath and heating in an air furnace.

In one or more embodiments detailed herein, the present invention is a method of manufacturing an aluminum alloy heat-treated product in an inline or off-line process comprising obtaining an ingot; at least one of hot rolling or cold rolling the ingot to form a feedstock; induction heating the feedstock and quenching the feedstock to form a heat-treated product having a T temper.

In one or more embodiments detailed herein, the method includes obtaining an ingot. In one or more embodiments detailed herein, the obtaining step comprises casting the ingot using a non-continuous casting process such as direct chill casting.

In one or more embodiments detailed herein, the aluminum alloy is a 6xxx series aluminum alloy selected from the group consisting of AA6022, AA6111, AA6016, AA6061, AA6013, AA6063, and AA6055.

In one or more embodiments detailed herein, the heating is conducted using induction heating. In one or more embodiments detailed herein, the induction heating is conducted using at least one heater that is configured for transverse flux induction heating (“TFIH”).

In one or more embodiments detailed herein, the dissolution during the induction heating step conducted at a first temperature is greater than the dissolution of heating using an air furnace at the same temperature. In one or more embodiments detailed herein, the dissolution during the induction heating step conducted at a first temperature is greater than the dissolution of heating using a molten lead bath at the same temperature.

In one or more embodiments detailed herein, the induction heating step is conducted at a sufficient heating temperature so that the heat-treated product has a volume percent of soluble secondary phase particles of less than 0.1%. In one or more embodiments detailed herein, the induction heating step is conducted at a sufficient heating temperature and a sufficient heating duration so that the heat-treated product has a volume percent of soluble secondary phase particles of less than 0.1%.

In one or more embodiments detailed herein, the sufficient heating temperature so that the heat-treated product has a volume percent of soluble secondary phase particles of less than 0.1% is 930 to 975 degrees F. In one or more embodiments detailed herein, the sufficient heating temperature so that the heat-treated product has a volume percent of soluble secondary phase particles of less than 0.1% is 940 to 975 degrees F. In one or more embodiments detailed herein, the sufficient heating temperature so that the heat-treated product has a volume percent of soluble secondary phase particles of less than 0.1% is 950 to 975 degrees F. In one or more embodiments detailed herein, the sufficient heating temperature so that the heat-treated product has a volume percent of soluble secondary phase particles of less than 0.1% is 960 to 975 degrees F. In one or more embodiments detailed herein, the sufficient heating temperature so that the heat-treated product has a volume percent of soluble secondary phase particles of less than 0.1% is 970 to 975 degrees F.

In one or more embodiments detailed herein, the sufficient heating temperature so that the heat-treated product has a volume percent of soluble secondary phase particles of less than 0.1% is 930 to 970 degrees F. In one or more embodiments detailed herein, the sufficient heating temperature so that the heat-treated product has a volume percent of soluble secondary phase particles of less than 0.1% is 930 to 960 degrees F. In one or more embodiments detailed herein, the sufficient heating temperature so that the heat-treated product has a volume percent of soluble secondary phase particles of less than 0.1% is 930 to 950 degrees F. In one or more embodiments detailed herein, the sufficient heating temperature so that the heat-treated product has a volume percent of soluble secondary phase particles of less than 0.1% is 930 to 940 degrees F.

In one or more embodiments detailed herein, the sufficient heating temperature so that the heat-treated product has a volume percent of soluble secondary phase particles of less than 0.1% is 940 to 970 degrees F. In one or more embodiments detailed herein, the sufficient heating temperature so that the heat-treated product has a volume percent of soluble secondary phase particles of less than 0.1% is 950 to 960 degrees F.

In one or more embodiments detailed herein, the sufficient heating temperature and the sufficient heating duration so that the heat-treated product has a volume percent of soluble secondary phase particles of less than 0.1% are 930 to 975 degrees F. and 10 seconds to 70 seconds. In one or more embodiments detailed herein, the sufficient heating temperature and the sufficient heating duration so that the heat-treated product has a volume percent of soluble secondary phase particles of less than 0.1% are 940 to 975 degrees F. and 10 seconds to 70 seconds. In one or more embodiments detailed herein, the sufficient heating temperature and the sufficient heating duration so that the heat-treated product has a volume percent of soluble secondary phase particles of less than 0.1% are 950 to 975 degrees F. and 10 seconds to 70 seconds. In one or more embodiments detailed herein, the sufficient heating temperature and the sufficient heating duration so that the heat-treated product has a volume percent of soluble secondary phase particles of less than 0.1% are 960 to 975 degrees F. and 10 seconds to 70 seconds. In one or more embodiments detailed herein, the sufficient heating temperature and the sufficient heating duration so that the heat-treated product has a volume percent of soluble secondary phase particles of less than 0.1% are 970 to 975 degrees F. and 10 seconds to 70 seconds.

In one or more embodiments detailed herein, the sufficient heating temperature and the sufficient heating duration so that the heat-treated product has a volume percent of soluble secondary phase particles of less than 0.1% are 930 to 970 degrees F. and 10 seconds to 70 seconds. In one or more embodiments detailed herein, the sufficient heating temperature and the sufficient heating duration so that the heat-treated product has a volume percent of soluble secondary phase particles of less than 0.1% are 930 to 960 degrees F. and 10 seconds to 70 seconds. In one or more embodiments detailed herein, the sufficient heating temperature and the sufficient heating duration so that the heat-treated product has a volume percent of soluble secondary phase particles of less than 0.1% are 930 to 950 degrees F. and 10 seconds to 70 seconds. In one or more embodiments detailed herein, the sufficient heating temperature and the sufficient heating duration so that the heat-treated product has a volume percent of soluble secondary phase particles of less than 0.1% are 930 to 940 degrees F. and 10 seconds to 70 seconds.

In one or more embodiments detailed herein, the sufficient heating temperature and the sufficient heating duration so that the heat-treated product has a volume percent of soluble secondary phase particles of less than 0.1% are 940 to 970 degrees F. and 10 seconds to 70 seconds. In one or more embodiments detailed herein, the sufficient heating temperature and the sufficient heating duration so that the heat-treated product has a volume percent of soluble secondary phase particles of less than 0.1% are 950 to 960 degrees F. and 10 seconds to 70 seconds.

In one or more embodiments detailed herein, the sufficient heating temperature and the sufficient heating duration so that the heat-treated product has a volume percent of soluble secondary phase particles of less than 0.1% are 930 to 975 degrees F. and 20 seconds to 70 seconds. In one or more embodiments detailed herein, the sufficient heating temperature and the sufficient heating duration so that the heat-treated product has a volume percent of soluble secondary phase particles of less than 0.1% are 930 to 975 degrees F. and 30 seconds to 70 seconds. In one or more embodiments detailed herein, the sufficient heating temperature and the sufficient heating duration so that the heat-treated product has a volume percent of soluble secondary phase particles of less than 0.1% are 930 to 975 degrees F. and 40 seconds to 70 seconds. In one or more embodiments detailed herein, the sufficient heating temperature and the sufficient heating duration so that the heat-treated product has a volume percent of soluble secondary phase particles of less than 0.1% are 930 to 975 degrees F. and 50 seconds to 70 seconds. In one or more embodiments detailed herein, the sufficient heating temperature and the sufficient heating duration so that the heat-treated product has a volume percent of soluble secondary phase particles of less than 0.1% are 930 to 975 degrees F. and 60 seconds to 70 seconds.

In one or more embodiments detailed herein, the sufficient heating temperature and the sufficient heating duration so that the heat-treated product has a volume percent of soluble secondary phase particles of less than 0.1% are 930 to 975 degrees F. and 10 seconds to 60 seconds. In one or more embodiments detailed herein, the sufficient heating temperature and the sufficient heating duration so that the heat-treated product has a volume percent of soluble secondary phase particles of less than 0.1% are 930 to 975 degrees F. and 10 seconds to 50 seconds. In one or more embodiments detailed herein, the sufficient heating temperature and the sufficient heating duration so that the heat-treated product has a volume percent of soluble secondary phase particles of less than 0.1% are 930 to 975 degrees F. and 10 seconds to 40 seconds. In one or more embodiments detailed herein, the sufficient heating temperature and the sufficient heating duration so that the heat-treated product has a volume percent of soluble secondary phase particles of less than 0.1% are 930 to 975 degrees F. and 10 seconds to 30 seconds. In one or more embodiments detailed herein, the sufficient heating temperature and the sufficient heating duration so that the heat-treated product has a volume percent of soluble secondary phase particles of less than 0.1% are 930 to 975 degrees F. and 10 seconds to 20 seconds.

In one or more embodiments detailed herein, the sufficient heating temperature and the sufficient heating duration so that the heat-treated product has a volume percent of soluble secondary phase particles of less than 0.1% are 930 to 975 degrees F. and 20 seconds to 60 seconds. In one or more embodiments detailed herein, the sufficient heating temperature and the sufficient heating duration so that the heat-treated product has a volume percent of soluble secondary phase particles of less than 0.1% are 930 to 975 degrees F. and 30 seconds to 50 seconds.

In one or more embodiments detailed herein, the sufficient heating temperature so that the heat-treated product has a volume percent of soluble secondary phase particles of less than 0.05% is 950 to 985 degrees F. In one or more embodiments detailed herein, the sufficient heating temperature so that the heat-treated product has a volume percent of soluble secondary phase particles of less than 0.05% is 960 to 985 degrees F. In one or more embodiments detailed herein, the sufficient heating temperature so that the heat-treated product has a volume percent of soluble secondary phase particles of less than 0.05% is 970 to 985 degrees F.

In one or more embodiments detailed herein, the sufficient heating temperature so that the heat-treated product has a volume percent of soluble secondary phase particles of less than 0.05% is 950 to 970 degrees F. In one or more embodiments detailed herein, the sufficient heating temperature so that the heat-treated product has a volume percent of soluble secondary phase particles of less than 0.05% is 950 to 960 degrees F.

In one or more embodiments detailed herein, the sufficient heating temperature and the sufficient heating duration so that the heat-treated product has a volume percent of soluble secondary phase particles of less than 0.05% are 950 to 985 degrees F. and 10 seconds to 70 seconds. In one or more embodiments detailed herein, the sufficient heating temperature and the sufficient heating duration so that the heat-treated product has a volume percent of soluble secondary phase particles of less than 0.05% are 960 to 985 degrees F. and 10 seconds to 70 seconds. In one or more embodiments detailed herein, the sufficient heating temperature and the sufficient heating duration so that the heat-treated product has a volume percent of soluble secondary phase particles of less than 0.05% are 970 to 985 degrees F. and 10 seconds to 70 seconds.

In one or more embodiments detailed herein, the sufficient heating temperature and the sufficient heating duration so that the heat-treated product has a volume percent of soluble secondary phase particles of less than 0.05% are 950 to 970 degrees F. and 10 seconds to 70 seconds. In one or more embodiments detailed herein, the sufficient heating temperature and the sufficient heating duration so that the heat-treated product has a volume percent of soluble secondary phase particles of less than 0.05% are 950 to 960 degrees F. and 10 seconds to 70 seconds.

In one or more embodiments detailed herein, the sufficient heating temperature and the sufficient heating duration so that the heat-treated product has a volume percent of soluble secondary phase particles of less than 0.05% are 950 to 985 degrees F. and 10 seconds to 50 seconds. In one or more embodiments detailed herein, the sufficient heating temperature and the sufficient heating duration so that the heat-treated product has a volume percent of soluble secondary phase particles of less than 0.05% are 950 to 985 degrees F. and 10 seconds to 30 seconds. In one or more embodiments detailed herein, the sufficient heating temperature and the sufficient heating duration so that the heat-treated product has a volume percent of soluble secondary phase particles of less than 0.05% are 950 to 985 degrees F. and 30 seconds to 70 seconds. In one or more embodiments detailed herein, the sufficient heating temperature and the sufficient heating duration so that the heat-treated product has a volume percent of soluble secondary phase particles of less than 0.05% are 950 to 985 degrees F. and 50 seconds to 70 seconds.

In one or more embodiments detailed herein, a first sufficient heating temperature for an induction heat-treated product having a volume percent of soluble secondary phase particles of less than 0.1% is less than a second sufficient heating temperature for a molten lead bath heat-treated product having the same volume percent of soluble secondary phase particles. In one or more embodiments detailed herein, a first sufficient heating temperature for an induction heat-treated product having a volume percent of soluble secondary phase particles of less than 0.1% is less than a second sufficient heating temperature for an air furnace heat-treated product having the same volume percent of soluble secondary phase particles.

In one or more embodiments detailed herein, a first sufficient heating temperature for an induction heat-treated product having a volume percent of soluble secondary phase particles of less than 0.05% is less than a second sufficient heating temperature for a molten lead bath heat-treated product having the same volume percent of soluble secondary phase particles. In one or more embodiments detailed herein, a first sufficient heating temperature for an induction heat-treated product having a volume percent of soluble secondary phase particles of less than 0.05% is less than a second sufficient heating temperature for an air furnace heat-treated product having the same volume percent of soluble secondary phase particles.

In one or more embodiments detailed herein, the aluminum alloy is a 6xxx series aluminum alloy and a first sufficient heating temperature for an induction heat-treated product having a volume percent of Mg2Si particles of less than 0.3% is less than a second sufficient heating temperature for a molten lead bath heat-treated product having the same volume percent of Mg2Si particles. In one or more embodiments detailed herein, the aluminum alloy is a 6xxx series aluminum alloy and a first sufficient heating temperature for an induction heat-treated product having a volume percent of Mg2Si particles of less than 0.3% is less than a second sufficient heating temperature for an air furnace heat-treated product having the same volume percent of Mg2Si particles.

In one or more embodiments detailed herein, the aluminum alloy is a 6xxx series aluminum alloy and a first sufficient heating temperature for an induction heat-treated product having a volume percent of Mg2Si particles of less than 0.2% is less than a second sufficient heating temperature for a molten lead bath heat-treated product having the same volume percent of Mg2Si particles. In one or more embodiments detailed herein, the aluminum alloy is a 6xxx series aluminum alloy and a first sufficient heating temperature for an induction heat-treated product having a volume percent of Mg2Si particles of less than 0.2% is less than a second sufficient heating temperature for an air furnace heat-treated product having the same volume percent of Mg2Si particles.

In one or more embodiments detailed herein, the aluminum alloy is a 6xxx series aluminum alloy and a first sufficient heating temperature for an induction heat-treated product having a volume percent of Mg2Si particles of less than 0.15% is less than a second sufficient heating temperature for a molten lead bath heat-treated product having the same volume percent of Mg2Si particles. In one or more embodiments detailed herein, the aluminum alloy is a 6xxx series aluminum alloy and a first sufficient heating temperature for an induction heat-treated product having a volume percent of Mg2Si particles of less than 0.15% is less than a second sufficient heating temperature for an air furnace heat-treated product having the same volume percent of Mg2Si particles.

In one or more embodiments detailed herein, the aluminum alloy is a 6xxx series aluminum alloy and a first sufficient heating temperature for an induction heat-treated product having a volume percent of Mg2Si particles of less than 0.1% is less than a second sufficient heating temperature for a molten lead bath heat-treated product having the same volume percent of Mg2Si particles. In one or more embodiments detailed herein, the aluminum alloy is a 6xxx series aluminum alloy and a first sufficient heating temperature for an induction heat-treated product having a volume percent of Mg2Si particles of less than 0.1% is less than a second sufficient heating temperature for an air furnace heat-treated product having the same volume percent of Mg2Si particles.

In one or more embodiments detailed herein, the aluminum alloy is a 6xxx series aluminum alloy and a first sufficient heating temperature for an induction heat-treated product having a volume percent of Mg2Si particles of less than 0.05% is less than a second sufficient heating temperature for a molten lead bath heat-treated product having the same volume percent of Mg2Si particles. In one or more embodiments detailed herein, the aluminum alloy is a 6xxx series aluminum alloy and a first sufficient heating temperature for an induction heat-treated product having a volume percent of Mg2Si particles of less than 0.05% is less than a second sufficient heating temperature for an air furnace heat-treated product having the same volume percent of Mg2Si particles.

In one or more embodiments detailed herein, the aluminum alloy is selected from a 2xxx, 5xxx, and 7xxx series aluminum alloy and a first sufficient heating temperature for an induction heat-treated product having a volume percent of soluble secondary phase particles of less than 0.3% is less than a second sufficient heating temperature for a molten lead bath heat-treated product having the same volume percent of soluble secondary phase particles. In one or more embodiments detailed herein, the aluminum alloy is selected from a 2xxx, 5xxx and 7xxx series aluminum alloy and a first sufficient heating temperature for an induction heat-treated product having a volume percent of soluble secondary phase particles of less than 0.3% is less than a second sufficient heating temperature for an air furnace heat-treated product having the same volume percent of soluble secondary phase particles.

In one or more embodiments detailed herein, the aluminum alloy is selected from a 2xxx, 5xxx and 7xxx series aluminum alloy and a first sufficient heating temperature for an induction heat-treated product having a volume percent of soluble secondary phase particles of less than 0.2% is less than a second sufficient heating temperature for a molten lead bath heat-treated product having the same volume percent of soluble secondary phase particles. In one or more embodiments detailed herein, the aluminum alloy is selected from a 2xxx, 5xxx and 7xxx series aluminum alloy and a first sufficient heating temperature for an induction heat-treated product having a volume percent of soluble secondary phase particles of less than 0.2% is less than a second sufficient heating temperature for an air furnace heat-treated product having the same volume percent of soluble secondary phase particles.

In one or more embodiments detailed herein, the aluminum alloy is selected from a 2xxx, 5xxx and 7xxx series aluminum alloy and a first sufficient heating temperature for an induction heat-treated product having a volume percent of soluble secondary phase particles of less than 0.15% is less than a second sufficient heating temperature for a molten lead bath heat-treated product having the same volume percent of soluble secondary phase particles. In one or more embodiments detailed herein, the aluminum alloy is selected from a 2xxx, 5xxx and 7xxx series aluminum alloy and a first sufficient heating temperature for an induction heat-treated product having a volume percent of soluble secondary phase particles of less than 0.15% is less than a second sufficient heating temperature for an air furnace heat-treated product having the same volume percent of soluble secondary phase particles.

In one or more embodiments detailed herein, the aluminum alloy is selected from a 2xxx, 5xxx and 7xxx series aluminum alloy and a first sufficient heating temperature for an induction heat-treated product having a volume percent of soluble secondary phase particles of less than 0.1% is less than a second sufficient heating temperature for a molten lead bath heat-treated product having the same volume percent of soluble secondary phase particles. In one or more embodiments detailed herein, the aluminum alloy is selected from a 2xxx, 5xxx and 7xxx series aluminum alloy and a first sufficient heating temperature for an induction heat-treated product having a volume percent of soluble secondary phase particles of less than 0.1% is less than a second sufficient heating temperature for an air furnace heat-treated product having the same volume percent of soluble secondary phase particles.

In one or more embodiments detailed herein, the aluminum alloy is selected from a 2xxx, 5xxx and 7xxx series aluminum alloy and a first sufficient heating temperature for an induction heat-treated product having a volume percent of soluble secondary phase particles of less than 0.05% is less than a second sufficient heating temperature for a molten lead bath heat-treated product having the same volume percent of soluble secondary phase particles. In one or more embodiments detailed herein, the aluminum alloy is selected from a 2xxx, 5xxx and 7xxx series aluminum alloy and a first sufficient heating temperature for an induction heat-treated product having a volume percent of soluble secondary phase particles of less than 0.05% is less than a second sufficient heating temperature for an air furnace heat-treated product having the same volume percent of soluble secondary phase particles.

In one or more embodiments detailed herein, the aluminum alloy is an aluminum alloy is selected from the group consisting of 1xxx, 2xxx, 3xxx, 4xxx, 5xxx, 6xxx, 7xxx, and 8xxx series aluminum alloys. In one or more embodiments detailed herein, the aluminum alloy is an aluminum alloy selected from the group consisting of 2xxx, 3xxx, 4xxx, 5xxx, 6xxx, 7xxx, and 8xxx series aluminum alloys. In one or more embodiments detailed herein, the aluminum alloy is a 2xxx series aluminum alloy. In one or more embodiments detailed herein, the aluminum alloy is a 3xxx series aluminum alloy. In one or more embodiments detailed herein, the aluminum alloy is a 4xxx series aluminum alloy. In one or more embodiments detailed herein, the aluminum alloy is a 5xxx series aluminum alloy. In one or more embodiments detailed herein, the aluminum alloy is a 6xxx series aluminum alloy. In one or more embodiments detailed herein, the aluminum alloy is a 7xxx series aluminum alloy. In one or more embodiments detailed herein, the aluminum alloy is an 8xxx series aluminum alloy.

In one or more embodiments detailed herein, the aluminum alloy is a 2xxx series aluminum alloy selected from the group consisting of AA2x24 (AA2024, AA2026, AA2524), AA2014, AA2029, AA2055, AA2060, AA2070, and AA2x99 (AA2099, AA2199).

In some embodiments, the aluminum alloy is a 5xxx series aluminum alloy selected from the group consisting of AA5182, AA5754, and AA5042.

In one or more embodiments detailed herein, the aluminum alloy is a 7xxx series aluminum alloy selected from the group consisting of AA7x75 (AA7075, AA7175, AA7475), AA7010, AA7050, AA7150, AA7055, AA7255, AA7065, and AA7085.

In one or more embodiments detailed herein, the induction heating step is conducted at a temperature of 600 degrees F. to 1100 degrees F. In one or more embodiments detailed herein, the induction heating step is conducted at a temperature of 700 degrees F. to 1100 degrees F. In one or more embodiments detailed herein, the induction heating step is conducted at a temperature of 800 degrees F. to 1100 degrees F. In one or more embodiments detailed herein, the induction heating step is conducted at a temperature of 900 degrees F. to 1100 degrees F. In one or more embodiments detailed herein, the induction heating step is conducted at a temperature of 1000 degrees F. to 1100 degrees F.

In one or more embodiments detailed herein, the induction heating step is conducted at a temperature of 600 degrees F. to 1000 degrees F. In one or more embodiments detailed herein, the induction heating step is conducted at a temperature of 600 degrees F. to 900 degrees F. In one or more embodiments detailed herein, the induction heating step is conducted at a temperature of 600 degrees F. to 800 degrees F. In one or more embodiments detailed herein, the induction heating step is conducted at a temperature of 600 degrees F. to 700 degrees F.

In one or more embodiments detailed herein, the quenching is conducted using liquid sprays, gas, gas followed by liquid, and/or liquid followed by gas. In one or more embodiments detailed herein, the heat-treated product is a strip having a T temper. In one or more embodiments detailed herein, the heat treated product has a temper of T4. In one or more embodiments detailed herein, the heat treated product is allowed to reach T4 temper at room temperature.

Air furnace heat treatment and molten lead bath heat treatment are known in the art. An example of air furnace heat treatment and molten lead bath heat treatment is detailed below.

Procedure for Calculating Volume Percent of Mg2Si Particles

The following is the procedure for calculating the volume percent of Mg2Si particles in a heat-treated product:

Step 1. Preparation of the Product for Scanning Electron Microscope Imaging

Longitudinal (L-ST) samples of the product are ground for about 30 seconds using progressively finer grit paper starting at 240 grit and followed by 320, 400, and 600 grit paper. After grinding, the samples are polished for about 2-3 minutes on cloths using a sequence of (a) 3 micron mol cloth and 3 micron diamond suspension, (b) 3 micron silk cloth and 3 micron diamond suspension, and (c) a 1 micron silk cloth and 1 micron diamond suspension. During polishing, an appropriate oil-based lubricant may be used. A final polish prior to SEM examination is made using 0.05 micron colloidal silica for about 30 seconds, followed by a final rinse under water.

Step 2. SEM Image Collection

A minimum of 16 backscattered electron images are captured at both the center (T/2) and quarter thickness (T/4) of the metallographically prepared (per step 1, above) longitudinal (L-ST) sections using an FEI XL30 FEG SEM, or comparable FEG SEM. The image size is 2048 pixels by 1600 pixels at a magnification of 1000X. The pixel dimensions are x=0.059 μm, y=0.059 μm. The accelerating voltage is 7.5 kV at a working distance of 7.5 mm and spot size of 5. The contrast and brightness are set so that the average matrix grey level of the 8-bit digital image is approximately 128 and the darkest and brightest phases are 0 (black) and 255 (white) respectively.

Step 3. Discrimination of Secondary Phase Particles

The average matrix grey level and standard deviation are calculated for each image. The average atomic number of the secondary phase particles of interest is smaller than the matrix (the aluminum matrix), so the secondary phase particles will appear dark in the image representations. The pixels that make up the particles are defined as any pixel that has a grey level less than (<) the average matrix grey level minus 3.5 standard deviations. This critical grey level is defined as the threshold. A binary image is created by discriminating the grey level image to make all pixels lower than the threshold to be white (255) and all pixels at or higher than the threshold to be black (0).

Step 4. Removal of Small Particles

Any white particle that has 4 or fewer pixels is removed from the binary image by changing its color to the background color (black).

Step 5. Calculation of Volume Percent of Mg2Si Particles:

Once each image is converted into solely black and white pixels, the area fraction of particles is calculated as the total number of white pixels divided by the total number of pixels. This fraction is calculated for each image for a single location, and then averaged. The total area fraction (AF) for a given sample is then calculated as a weighted average of the area fraction at T/2 and T/4, where the T/4 number is weighted twice because it occurs twice in the sample. Area fraction is then converted into a percent by multiplying by 100. The volume percent of the Mg2Si particles in the product is then determined based on Equation (I):

Mg2Si Particles (vol. %)=100*(AF_{T/2}2*AF_{T/4})/3 (I)

AF=#WhitePixels/#TotalPixels

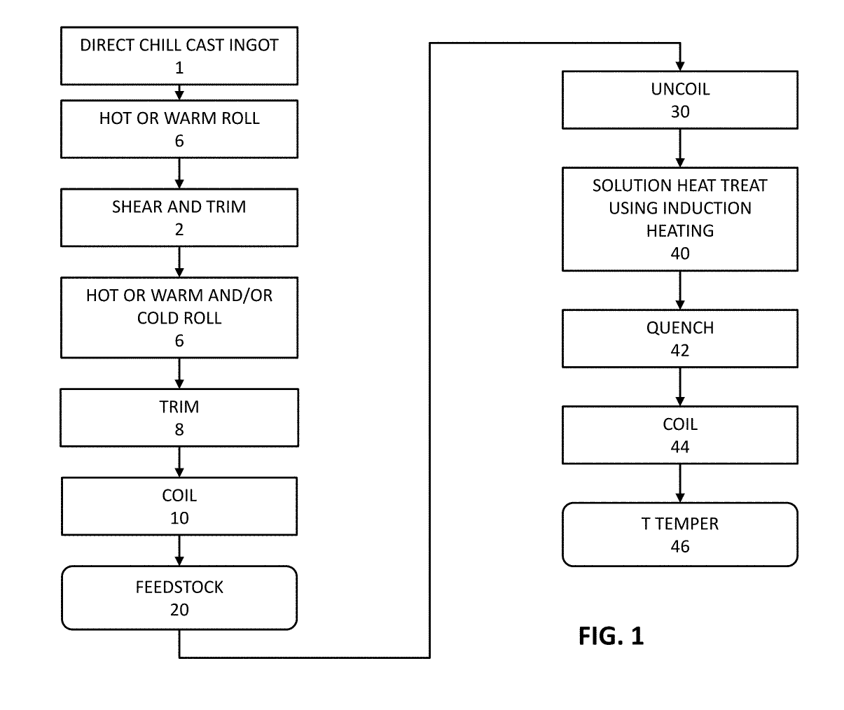

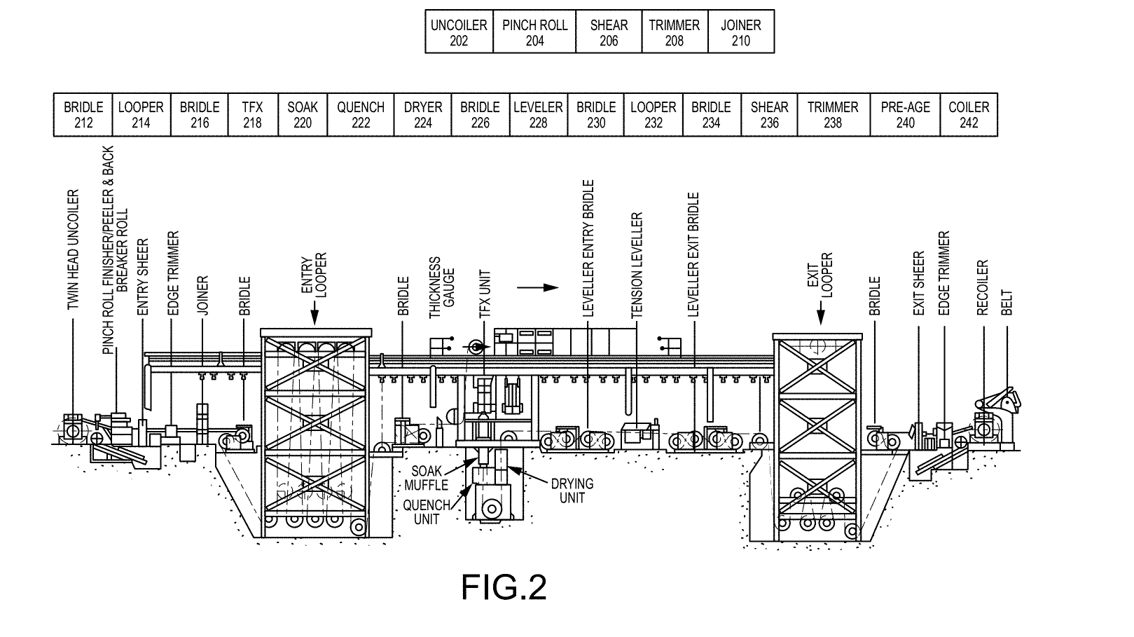

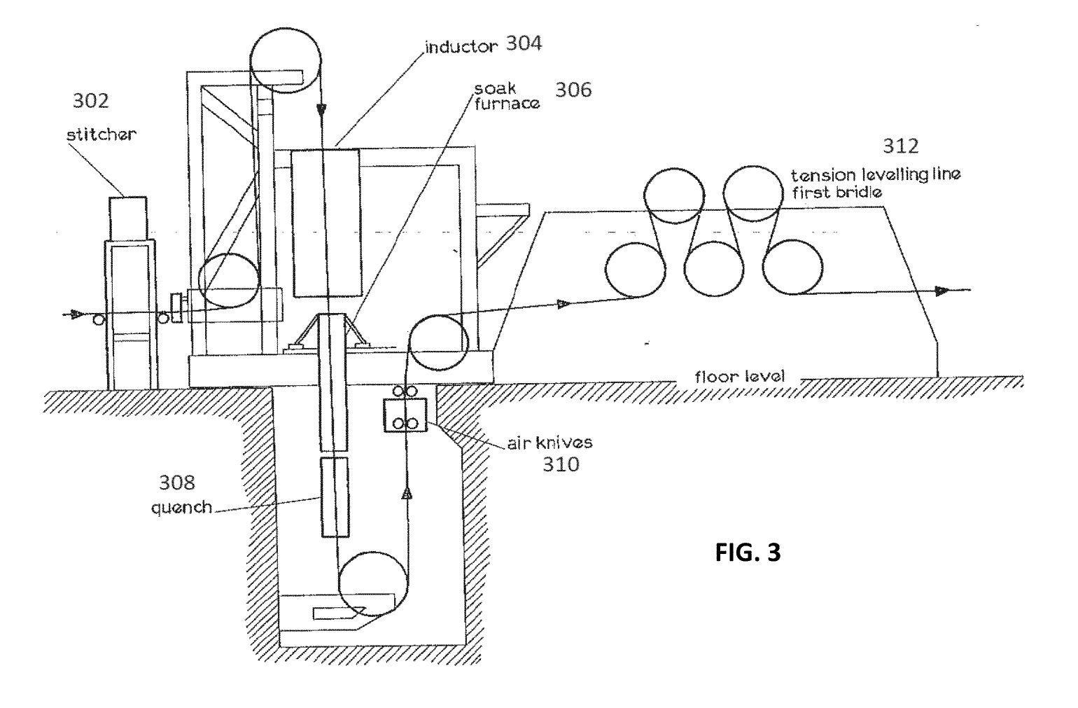

FIG. 1 is a flow chart of the steps of an embodiment of a method of the present invention that includes off-line heat treatment. In some embodiments, FIG. 2 is a schematic diagram of one embodiment of the apparatus used to carrying out the method of the present invention. In some embodiments, FIG. 3 is a schematic diagram of one embodiment of the apparatus used in carrying out the method of the present invention.

In some embodiments, the method includes the process detailed in FIG. 1. In some embodiments, the feedstock (20) is formed from a non-continuously cast—e.g., direct chill cast—aluminum alloy ingot 1 that is subjected to one or more of the following processing steps detailed in FIG. 1: passing through one or more shear and trim stations (2), optional quenching for temperature adjustment (4), one or more hot or warm rolling and/or cold rolling steps (6), trimming (8) and coiling (10) to form feedstock (20).

In some embodiments, the coiled feedstock is subjected to one or more of the following steps: uncoiling (30) followed by solution heat treatment (40), suitable quenching (42) and optional coiling (44) to produce T temper strips (46). In some embodiments, the solution heat treatment step (40) is conducted using the heating methods, temperature ranges, and heating durations detailed herein. In yet other embodiments, the method includes inline heat treatment and thus, eliminates at least the coiling step (10) and uncoiling step (30) of FIG. 1.

In some embodiments, an embodiment of an apparatus used to carry out the method of the present invention using induction heating is shown in FIG. 2. In some embodiments, the feedstock is processed in a horizontal heat treatment unit as shown in FIG. 2. FIG. 2 is adopted from R. C. J. Ireson, in Aluminium Technology '86, ed. T. Sheppard, The Inst. Metals, 1986, pp. 818-825. In some embodiments, the method includes use of an uncoiler (202) to uncoil the coiled feedstock. In some embodiments, the uncoiled feedstock is then fed to a pinch roll (204), shear (206), trimmer (208), and joiner (210). In some embodiments, the feedstock is then fed to a bridle (212), a looper (214), and another bridle (216). In some embodiments, the resultant feedstock is then fed one or more induction heaters (218) configured for TFIH. In some embodiments, the heated feedstock is then subjected to a soak (220), a quench (222) and a dryer (224). In some embodiments, the dried, heated feedstock is then fed to a bridle (226), leveler (228), and another bridle (230). In some embodiments, the feedstock is then fed to a lopper (232), a bridle (234), and then subjected to a shear (236), a trimmer (238), a pre-aging step (240) and then run through a coiler (242) to form a coiled strip.

In some embodiments, the quench (222) may include, but is not limited to, liquid sprays, gas, gas followed by liquid, and/or liquid followed by gas. In some embodiments, the pre-aging step may include, but is not limited to, induction heating, infrared heating, muffle furnace or liquid sprays. In some embodiments, the pre-age unit is positioned before the coiler (242). In some embodiments, artificial aging can be carried out either as a part of subsequent operations (such as paint bake cycle) or as a separate step in an oven.

In some embodiments, an embodiment of an apparatus used to carry out the method of the present invention using induction heating is shown in FIG. 3. FIG. 3 is adopted from R. Waggott et al., in Heat Treatment '81, The Metals Society, 1983, pp. 3-9. In some embodiments, the apparatus or the method includes a stitcher (302), an inductor (304) configured for TFIH, a soak furnace (306), a quench (308), air knives (310) and a tension leveling line first bridle (312).

### Non-Limiting Example 1

In this example, a 6022 aluminum alloy having the composition detailed in Table 1 was ingot cast, hot rolled to a thickness of 0.148 inches, and coiled.

TABLE 1

| Si | Fe | Cu | Mn | Mg | Cr | Ni | Zn | Ti |
|---|---|---|---|---|---|---|---|---|
| 0.845 | 0.126 | 0.044 | 0.073 | 0.589 | 0.031 | 0.0061 | 0.0098 | 0.021 |

Aside from the elements listed in Table 1, the remainder of the alloy was aluminum and other elements, with no other element exceeding 0.05 wt. %, and with the total of such other elements not exceeding 0.15 wt. %.

The coiled hot rolled product was then cold rolled to a thickness of 0.043 inches and recoiled. Samples from the cold rolled coil were then subjected to one of the three solution heat treatment methods detailed below:

Molten lead bath: A sample was submersed in a bath of liquid lead at the temperature detailed in Table 3 for a heating duration detailed in Table 2. The sample was then removed from the bath and immediately quenched in a bath of room temperature water. The temperature specified in Table 3 indicates the temperature of the liquid lead as measured by thermocouple. The temperature of the sample was also determined from thermocouple measurements, and based on these measurements, the total heating duration of 30 seconds was determined based on a heating time of 5 seconds and a hold time of 25 seconds.

Air furnace: A sample was placed inside a standard air furnace at the specified temperature detailed in Table 3 for a heating duration detailed in Table 2. The sample was then removed from the furnace and immediately quenched in a bath of room temperature water. The temperature specified indicates the temperature of the air inside the furnace as measured by thermocouple. The temperature of the sample was also determined from thermocouple measurements, and based on these measurements, the total heating duration of 360 seconds was determined based on a heating time of 120 seconds and a hold time of 240 seconds.

Induction Heating: A sample was run through the transverse flux heating process detailed in FIG. 2. The temperature of the sheet was then determined using a standard emissivity technique upon exit of the sheet from the induction heating process. The heating duration and hold time were calculated based on the length of the induction heating zone and the speed the sample was fed in the induction heating process. Based on these calculations, the total heating duration of 41-67 seconds was determined based on a heating time of 19-32 seconds and a hold time of 22-35 seconds.

All samples (molten lead bath, air furnace, and induction heating) were heat treated to a T4 temper. The heat treated samples were then measured for the volume percent of Mg2Si particles using the “Procedure for Calculating Volume Percent of Mg2Si Particles” detailed above. The results are shown in Table 3.

TABLE 2

| Heat Treatment Method | Heating Time | | Hold Time | | Quench |
|---|---|---|---|---|---|
| Molten lead bath | 5 | seconds | 25 | seconds | Water |
| Air furnace | 240 | seconds | 120 | seconds | Water |
| Induction heating | 19-32 | seconds | 22-35 | seconds | Water |

TABLE 3

| | Solution Heat Treatment | Mg2Si |
|---|---|---|
| Heat Treatment Method | Temperature (deg. F.) | (volume percent) |
| Molten lead bath | 940 | 0.309 |
| | 955 | 0.253 |
| | 985 | 0.132 |
| | 1045 | 0.03 |
| Induction Heating | 900 | 0.189 |
| | 955 | 0.04 |
| | 1010 | 0.01 |
| Air Furnace | 940 | 0.253 |
| | 955 | 0.186 |
| | 985 | 0.038 |
| | 1045 | 0.016 |

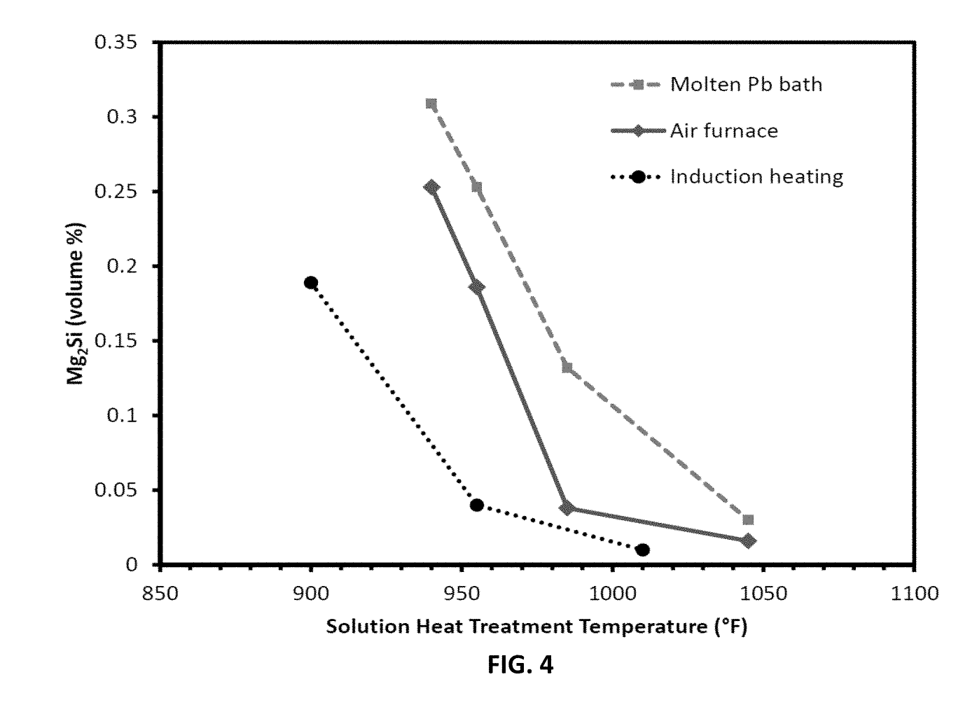

FIG. 4 graphs the solution heat treatment temperature (deg. F) and the Mg2Si (volume percent) data from Table 3. As shown in FIG. 4, the induction heated samples achieved greater dissolution of Mg2Si (i.e., a lower volume percent of Mg2Si in the heat treated product) at a lower temperature compared with the samples heated using a molten lead bath or air furnace. Thus, the induction heat treatment was more effective than the molten lead bath or air furnace heat treatment methods.

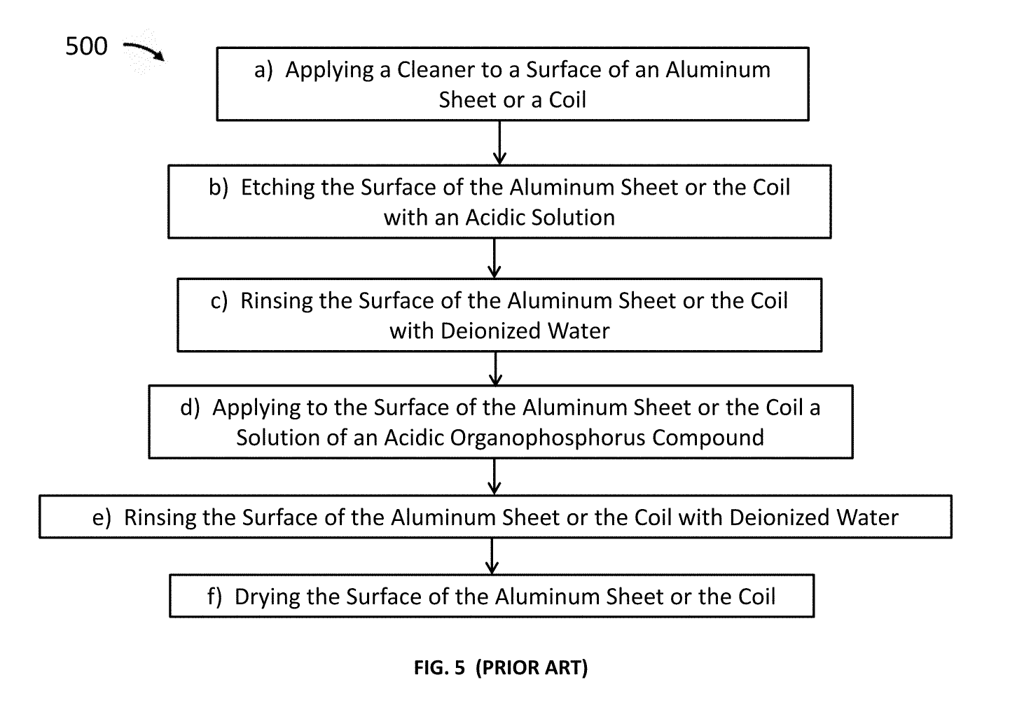

Referring now to FIG. 5, in a known process, exemplified by U.S. Patent Publication No. 2016/0319440, heat treated (e.g., using the induction heating methods disclosed herein) aluminum alloy product feedstock (e.g., sheet product) may be treated using a known method (500). The known method (500) includes the step of a) applying a cleaner to a surface of an aluminum alloy sheet or coil. The known method (500) includes the step of b) etching the surface of the aluminum sheet or the coil with an acidic solution. The known method (500) includes the step of c) rinsing the surface of the aluminum sheet or the coil with deionized water. The known method (500) includes the step of d) applying to the surface of the aluminum sheet or the coil a solution of an acidic organophosphorus compound. The known method (500) includes the step of e) rinsing the surface of the aluminum sheet or the coil with deionized water. The known method (500) includes the step of f) drying the surface of the aluminum sheet or the coil.

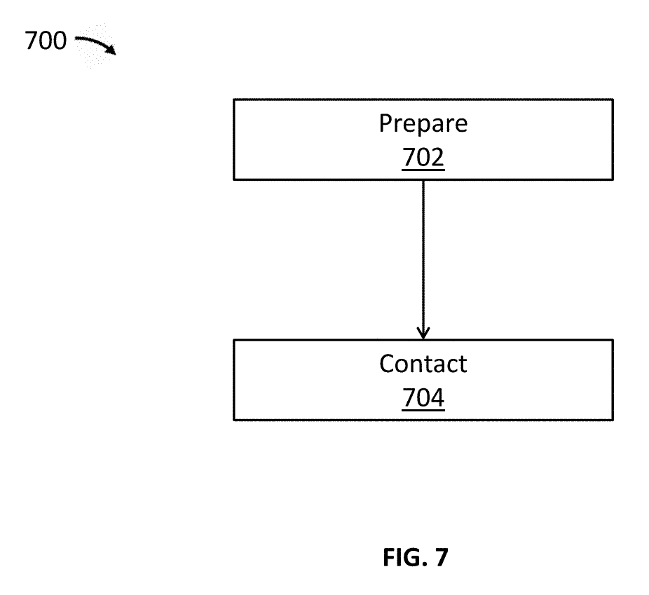

As described below, including by way of examples and with reference to FIGS. 7-13, the disclosed systems and methods provide for completing the known method (500) in the absence of at least steps a) and b), shown and described above with reference to FIG. 5.

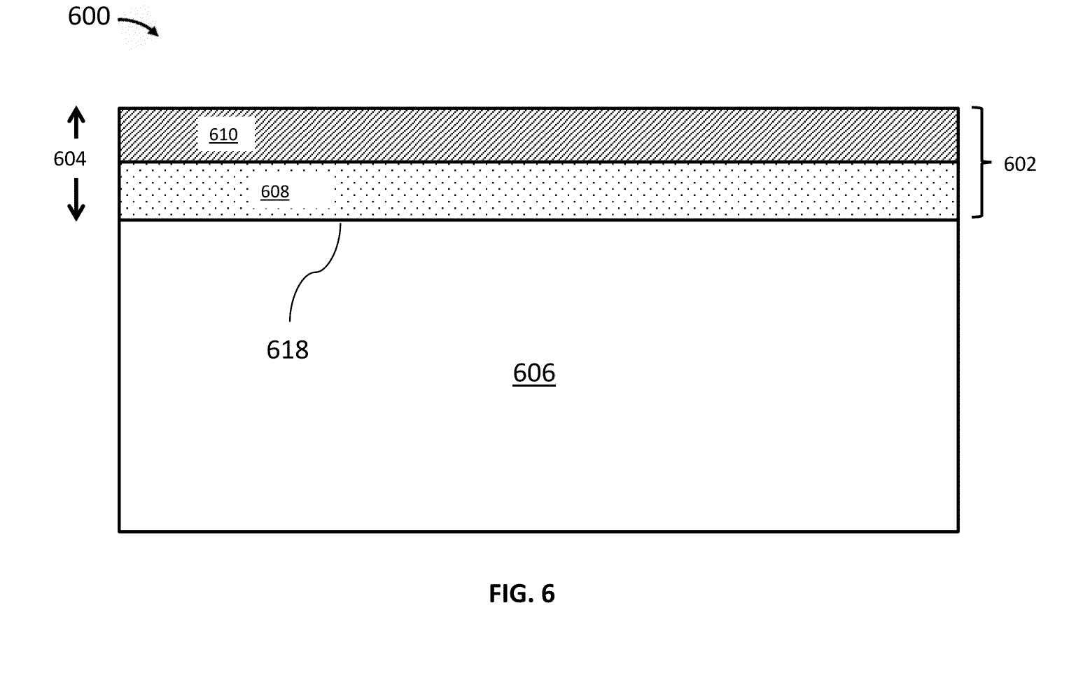

Referring now to FIG. 6, after completing the disclosed induction heating step, and, optionally, a post-induction heating quenching step, an induction heated aluminum alloy product (600) may have an aluminum alloy matrix (606) with a surface oxide layer (602) thereon. In one embodiment, the surface oxide layer (602) is formed starting at a plane approximating an interface (618) between the aluminum alloy matrix (606) and the surface oxide layer (602). The surface oxide layer (602) may include an aluminum oxide (e.g., AlO) sublayer (608) and a magnesium oxide (e.g., MgO) sublayer (610). The surface oxide layer (602) of the induction heated aluminum alloy product (600) generally has an as-induction heated thickness (604), generally from 5 nm to 60 nm thick, depending on temper. While the as-induction heated surface oxide layer (602) is illustrated as being generally uniform, the as-induction heated surface oxide layer (602) generally has a non-uniform topography.

As used herein, “second material” means a material to which at least a portion of an aluminum alloy product is bonded, thereby forming an as-bonded aluminum alloy product. In one embodiment, the at least a portion of the aluminum alloy product is a first portion of the aluminum alloy product, and the second material is a second portion of the same aluminum alloy product. In one embodiment, the at least a portion of the aluminum alloy product resides on a first aluminum alloy product piece, and the second material is at least a second portion of a second piece of material. In one embodiment, the second material has the same composition as the aluminum alloy product. In another embodiment, the second material has a different composition than the aluminum alloy product.

As used herein, “surface deoxidization” and “surface oxide treating steps” means removing at least a portion of the surface oxide layer of an aluminum alloy product.

As used herein, “etch,” “etched,” and “etching” means applying an acidic solution to the surface of the aluminum sheet or coil to prepare the surface to accept a subsequent application of a pretreatment. In a known embodiment (e.g., shown in FIG. 5), the etching removes from the surface loosely adhering oxides, including aluminum- and magnesium-rich oxides, entrapped oils, or debris. In one embodiment, “etch,” “etched,” and “etching” take on the definition(s) provided in U.S. Patent Publication No. 2016/0319440.

As used herein, “additively manufactured” means “a process of joining materials to make objects from 3D model data, usually layer upon layer, as opposed to subtractive manufacturing methodologies,” as defined in ASTM F2792-12A entitled “Standard Terminology for Additive Manufacturing Technologies.” Such materials may be manufactured via any appropriate additive manufacturing technique described in ASTM F2792-12A, such as binder jetting, directed energy deposition, material extrusion, material jetting, powder bed fusion, or sheet lamination, among others. Additive manufacturing processes are implemented, at least in part, by “additive systems,” as defined by ASTM F2792-12A.

Preparation of Aluminum Alloy Products by Surface Deoxidization

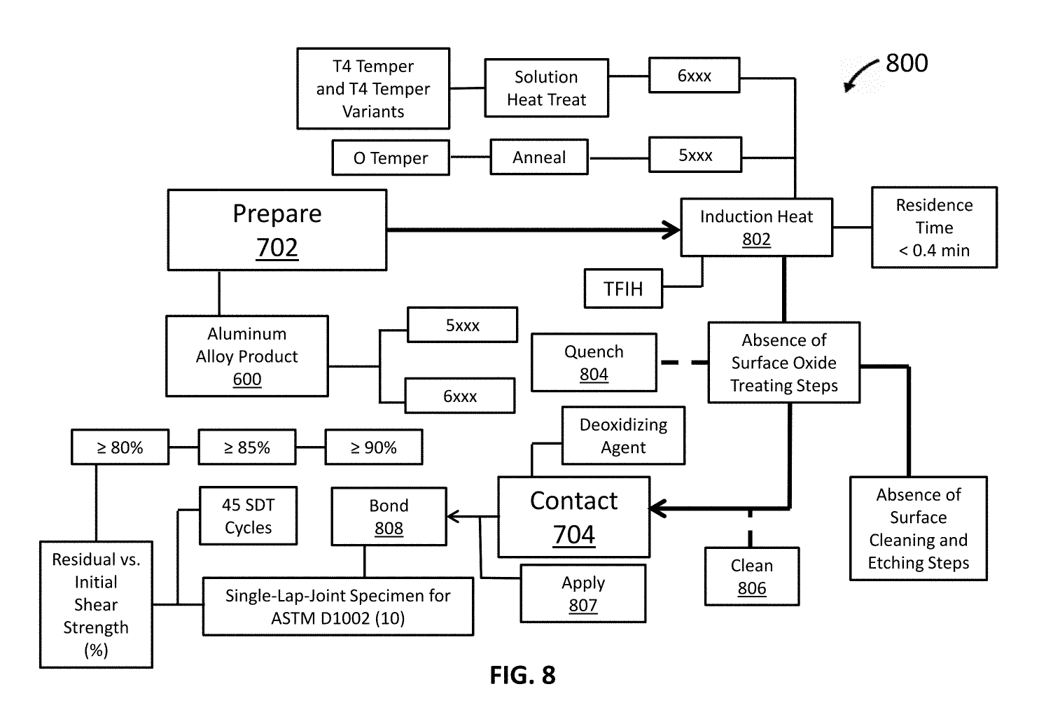

In an embodiment, and referring now to FIGS. 7 and 8, a method (700) includes the step of (a) preparing (702) an aluminum alloy product (e.g., the induction heated aluminum alloy product (600)) for surface deoxidization. In one embodiment (e.g., method (800)), the preparing step (a) includes induction heating (802), with an induction heater, at least a portion of an as-received aluminum alloy product (600) feedstock.

In one embodiment, the as-received aluminum alloy product (600) feedstock is a sheet product. In one embodiment, the sheet product has a gauge of from 0.5 to 6 mm after the induction heating (802) step and, optionally, the quenching (804) step. In another embodiment, the as-received aluminum alloy product (600) feedstock is an extruded product. In yet another embodiment, the as-received aluminum alloy product (600) feedstock is a forged product. In one embodiment, the forged product is a symmetric forging. In one embodiment, the forged product is a shaped forging. In still another embodiment, the as-received aluminum alloy product (600) feedstock is a cast product. In one embodiment, the cast product is a symmetric casting. In one embodiment, the cast product is a shaped casting. In another embodiment, the as-received aluminum alloy product (600) is an additively manufactured part.

In one embodiment, the induction heater includes a transverse flux induction heater (TFIH). In one embodiment, the induction heating (802) step is performed substantially as shown as described with reference to FIGS. 1-4, above. In one embodiment, the at least a portion of the aluminum alloy product (600) realizes a residence time of not greater than 0.4 minutes of induction heating (802). In another embodiment, the at least a portion of the aluminum alloy product (600) realizes a residence time of from 0.2 to 0.4 minutes of induction heating (802). In one embodiment, the at least a portion of the aluminum alloy product (600) realizes a peak metal temperature of from 900 to 1040° F. during the induction heating (802). In another embodiment, the at least a portion of the aluminum alloy product (600) realizes a peak metal temperature of from 900 to less than 1040° F. during the induction heating (802). In yet another embodiment, the at least a portion of the aluminum alloy product (600) realizes a peak metal temperature of from 930 to 1030° F. during the induction heating (802). In still another embodiment, the at least a portion of the aluminum alloy product (600) realizes a peak metal temperature of from 950 to 1020° F. during the induction heating (802). In yet another embodiment, the at least a portion of the aluminum alloy product (600) realizes a peak metal temperature of from 970 to 1000° F. during the induction heating (802).

In one embodiment, the induction heating (802) includes annealing or solution heat treating the aluminum alloy product (600). In one embodiment, the preparing (702) step includes quenching (804) the induction heated aluminum alloy product (600). In another embodiment, the preparing step (702) does not include quenching (804) the induction heated aluminum alloy product (600). In yet another embodiment, the quenching (804) step is optionally included for the preparing step (702).

In one embodiment, the as-received aluminum alloy product (600) is a 5xxx aluminum alloy product (600), and the induction heating (802) step is configured to accomplish an annealing of the 5xxx aluminum alloy product (600). In one embodiment, the induction heated 5xxx aluminum alloy product (600) is in the O-temper.

In another embodiment, the as-received aluminum alloy product (600) is a 6xxx aluminum alloy product (600), and the induction heating (802) step is configured to accomplish a solution heat treating of the 6xxx aluminum alloy product (600). In one embodiment, the induction heated 6xxx aluminum alloy product (600) is in the T4-temper. In another embodiment, the induction heated 6xxx aluminum alloy product (600) is in the T43-temper. In another embodiment, the induction heated 6xxx aluminum alloy product (600) is in the T4E32-temper.

In the embodiment, method (700) includes a contacting (704) step. In the embodiment, the contacting (704) step may be performed after the preparing (702) step. In the embodiment, the contacting (704) step may include contacting (704) the at least a portion of the induction heated and optionally quenched aluminum alloy product (600) with a deoxidizing agent. In method (800), between the preparing (702) and contacting (704) steps, the method (800) is absent of any surface oxide treating steps of the aluminum alloy product (800).

In one embodiment, between the preparing (702) step and the contacting (704) step the disclosed method is absent of any surface cleaning and etching treatments. In one embodiment, after the contacting (704) step the disclosed method is absent of any surface cleaning and etching treatments. In one embodiment, the method (800) includes cleaning (806) the at least a portion of the aluminum alloy product (600) between the preparing (702) step and the contacting (704) step.

In one embodiment, the method (800) may include a bonding (808) step. In the embodiment, the bonding (808) step may include applying (807) an adhesive bonding agent to the at least a portion of the aluminum alloy product (600), and then bonding (1106) the at least a portion of the aluminum alloy product (600) with a second material, thereby creating an as-bonded aluminum alloy product (600). In the embodiment, the bonding (808) step may include curing the adhesive bonding agent of the as-bonded aluminum alloy product (600) for a predetermined amount of time and/or at a predetermined temperature. In one embodiment, the at least a portion of the aluminum alloy product (600) includes a first portion of the aluminum alloy product (600), and the second material includes at least a second portion of the aluminum alloy product (600). In one embodiment, the as-bonded aluminum alloy product (600) may include the first portion of the aluminum alloy product (600) adhesively structurally bonded to the second material via the applied and/or cured adhesive bonding agent.

In one embodiment of method (800), when the as-bonded aluminum alloy product (600) is in a form of a single-lap-joint specimen having an aluminum metal-to-aluminum metal joint overlap of 0.5 inches, the as-bonded aluminum alloy product (600) achieves completion of 45 stress durability test (SDT) cycles according to ASTM D1002 (10), which is incorporated herein by reference in its entirety. In one embodiment, a residual shear strength of the single-lap-joint specimen after completing the 45 SDT cycles is at least 80% of an initial shear strength of the single-lap-joint specimen prior to commencing the 45 SDT cycles. In another embodiment, the residual shear strength of the single-lap-joint specimen after completing the 45 SDT cycles is at least 85% of the initial shear strength of the single-lap-joint specimen prior to commencing the 45 SDT cycles. In yet another embodiment, the residual shear strength of the single-lap-joint specimen after completing the 45 SDT cycles is at least 90% of the initial shear strength of the single-lap-joint specimen prior to commencing the 45 SDT cycles.

### Non-Limiting Example 2

The adhesive bonding response of aluminum alloy products prepared for surface deoxidization according to one embodiment of the disclosed method was evaluated by stress durability testing (SDT), according to ASTM D1002 (10) and where single-lap-joint specimens had an aluminum metal-to-aluminum metal joint overlap of 0.5 inches. One coil each from two production lots of 0.059 inch gauge 6022 aluminum alloy sheet product was uncoiled and then solution heat treated using a transverse flux induction heater. Prior to these uncoiling and induction heating steps, these 6022 aluminum alloy sheet products were prepared using a continuous casting technique. These 6022 aluminum alloy sheets proceeded through the induction heater with an induction heating residence time of 18 seconds and the peak metal temperatures (PMT) on the sheets were measured as 970° F. By contrast, the PMT of 6022-T4 aluminum alloy sheet product solution heat treated using conventional Continuous heat treatment (CHT) furnaces is typically from 1040-1060° F.

Upon exiting the induction heater, each of the two production lots of the induction heated 6022 aluminum alloy sheet products was quenched using deionized water at a temperature of 150° F. Mechanical properties of these sheets were measured after the induction heated 6022 aluminum alloy sheet products reached the T4 temper, and were found to be equivalent to or better than those obtained in CHT processed material. Next, the induction heated and quenched 6022-T4 aluminum alloy sheet products were contacted with an acidic solution of a deoxidizing agent at 170° F. for 6 seconds. These as-deoxidized 6022-T4 aluminum alloy sheet products were then coiled.

Two 6 inch×4 inch size pieces (with the 4 inch dimension being in the rolling direction) were removed from each of the two production lots of the as-deoxidized 6022-T4 aluminum alloy sheet product coil. Using the two pieces, four single-lap-joint specimens for each of these two production lots were prepared with a bonded joint overlap of 0.5 inches.

Each of the four single-lap-joint specimens of these two production lots of as-bonded 6022-T4 aluminum alloy sheet product were tested for initial bond shear strength using standard tensile testing equipment. Next, each of these two sets of the four single-lap-joint specimens were subjected to cyclic SDT in individual stress rings designed to apply 1080 psi shear stress to the joint. Each cycle consisted of a 15 minute dip in 5% NaCl solution at room temperature followed by 105 minute air drying, after which the ring and the specimen were placed in a 50° C. and 90% relative humidity chamber for 22 hours. The duration of each cycle was thus 24 hours. For each of the two specimen sets, each of the four single-lap-joint specimens of as-bonded 6022-T4 aluminum alloy sheet product was examined after each cycle, breakages were recorded, and failed specimens were removed from the testing chamber. For each of the two sets of specimens, the bonds of all specimens of the two sets of four single-lap-joint specimens of as-bonded 6022-T4 aluminum alloy sheet product had to complete 45 cycles in order to pass SDT.

After performing the SDT protocol, as described above, all of the single-lap-joint specimens were tested for residual bond shear strength using standard tensile testing equipment. For both the initial and residual bond shear strength tests, a failure mode was determined and recorded. The results obtained were compared with those from reference single-lap-joint specimens bonds made after the surfaces of the induction heated and quenched 6022-T4 aluminum alloy sheet product were prepared according to the known method described above with reference to FIG. 5. Four single-lap-joint specimens of the reference 6022-T4 aluminum alloy sheet product were prepared according to the procedure discussed above.

All single-lap-joint specimens of the as-bonded 6022-T4 aluminum alloy sheet product completed 45 cycles. The results of the initial and residual bond shear strength testing are shown in Table 4, below. “Sample 1” denotes a first production lot of 6022-T4 aluminum alloy sheet product, and “Sample 2” denotes a second production lot of 6022-T4 aluminum alloy sheet product.

TABLE 4

| | | | | | | | Residual |
|---|---|---|---|---|---|---|---|
| | Initial Shear Strength | | | Residual Shear Strength | | | v. Initial |
| | Shear | Mean Shear | | Shear | Mean Shear | | Shear |
| | Strength | Strength | Failure | Strength | Strength | Failure | Strength |
| | (psi) | (psi) | Mode | (psi) | (psi) | Mode | (%) |
| Sample 1 | 4667 | 4535 | adh | 4418 | 4555 | adh | 100 |
| | 4798 | | | 4490 | | | |
| | 4421 | | | 4757 | | | |
| | 4255 | | | N/A* | | | |
| Sample 2 | 5103 | 4927 | most | 4501 | 4803 | part | 97.5 |
| | 5096 | | coh | 4924 | | adh | |
| | 4989 | | | 5007 | | | |
| | 4520 | | | 4781 | | | |
| Reference | 4660 | 4697 | adh | 4356 | 4908 | part | 100 |
| | 4809 | | | 4888 | | adh | |
| | 4740 | | | 5097 | | | |
| | 4578 | | | 5291 | | | |

*For Sample 1, the fourth single-lap-joint specimen was not tested for residual bond shear strength.

In Table 4, above, the failure mode indicator “coh” denotes that the bond failure was due to failure of the bond glue. The failure mode indicator “adh” denotes that the bond failure was due to a complete failure of the adhesion interface between the glue and the metal surface. The failure mode indicator “part adh” denotes that the bond failure was due to a partial failure of the adhesion interface between the glue and the metal surface. Also, in Table 4, above, if the calculated percent (%) value for residual vs. initial bond shear strength was greater than 100%, then 100% was nevertheless indicated.

When compared to the initial bond shear strength, it was found that in all cases shown in Table 4, above, there was minimal or no loss of strength during the SDT protocol. By completing the 45 BDT cycles and showing a residual strength greater than 80% of the initial strength, these bonds tested after preparing these 6022-T4 aluminum alloy sheet products according to the disclosed method thus easily meet the requirements of structural adhesive bonds for auto applications in aluminum alloy 6022. Similarly good initial and residual bond shear strength results are also expected for aluminum alloy 6016-T4 prepared according to the disclosed method. Bonds of that alloy have already completed in excess of 100 cycles in SDT testing.

### Prophetic Example 3

A coil of 0.059 inch gauge 6022 aluminum alloy sheet product is uncoiled and then solution heat treated using a transverse flux induction heater. Prior to these uncoiling and induction heating steps, the 6022 aluminum alloy sheet products are prepared using a direct chill (DC) cast ingot rolling technique. This 6022 aluminum alloy sheet proceeds through the induction heater with an induction heating residence time of 9 seconds and the PMT on the sheet is measured to be 1020° F. By contrast, the PMT of 6022-T4 aluminum alloy sheet product solution heat treated using conventional Continuous heat treatment (CHT) furnaces is typically from 1040-1060° F.

Upon exiting the induction heater, this induction heated 6022 aluminum alloy sheet product is quenched using deionized water at a temperature of 150° F. Mechanical properties of the sheets are measured after the induction heated 6022 aluminum alloy sheet product reaches the T4 temper, and are found to be equivalent to or better than those obtained in CHT processed material. Next, two 6 inch×4 inch size pieces (with the 4 inch dimension being in the rolling direction) are removed from this 6022-T4 aluminum alloy sheet product coil. Each of the two pieces is washed in 150° F. deionized water for 8 seconds to remove lubricants and other contaminants from the preceding steps.

Next, four pieces of this 6022-T4 aluminum alloy sheet product are prepared according to the known method described above with reference to FIG. 5, where the acidic organophosphorus compound is maintained at 150° F. and contacts the sheet surface for 8 seconds to produce a functionalized layer on the surface of the sheet product. These four pieces are denoted as reference samples. In accordance with one embodiment of the disclosed method, the other four pieces are prepared without the functionalizing step (i.e., without the step of contacting the sheet surface with the acidic organophosphorus compound). These other four pieces are denoted as invention samples.

The adhesive bonding responses of single-lap-shear specimens prepared from the reference and inventive samples are evaluated in SDT by the techniques described above with reference to Non-Limiting Example 2. For both the reference and invention samples, all single-lap-joint specimens complete 45 cycles. Without being bound to any particular theory or mechanism, the results of this Prophetic Example 3 indicate that this embodiment of the disclosed method produces a surface that performs as well as or better in adhesive bonding than the metal prepared according to the known method of FIG. 5.

### Prophetic Example 4

To understand the results described above for Prophetic Example 3, a surface oxide of the induction heated 6022-T4 aluminum alloy sheet product invention sample of Prophetic Example 3 is analyzed by X-ray photoelectron spectroscopy (XPS). It is found that the induction heating-based method produces a much thinner oxide on the surface during the induction heat treatment, as compared to the surface oxide thickness resulting from the CHT-based technique. This surface oxide is only 5.4 nm thick, as compared to the typical 10 nm or more surface oxide layer thickness that is normally present on CHT-treated metal of the same aluminum alloy.

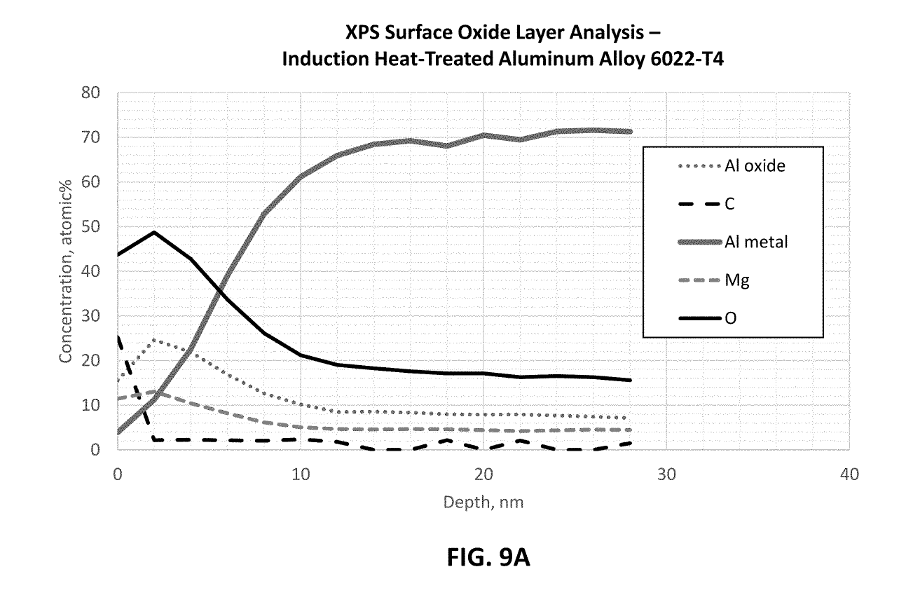

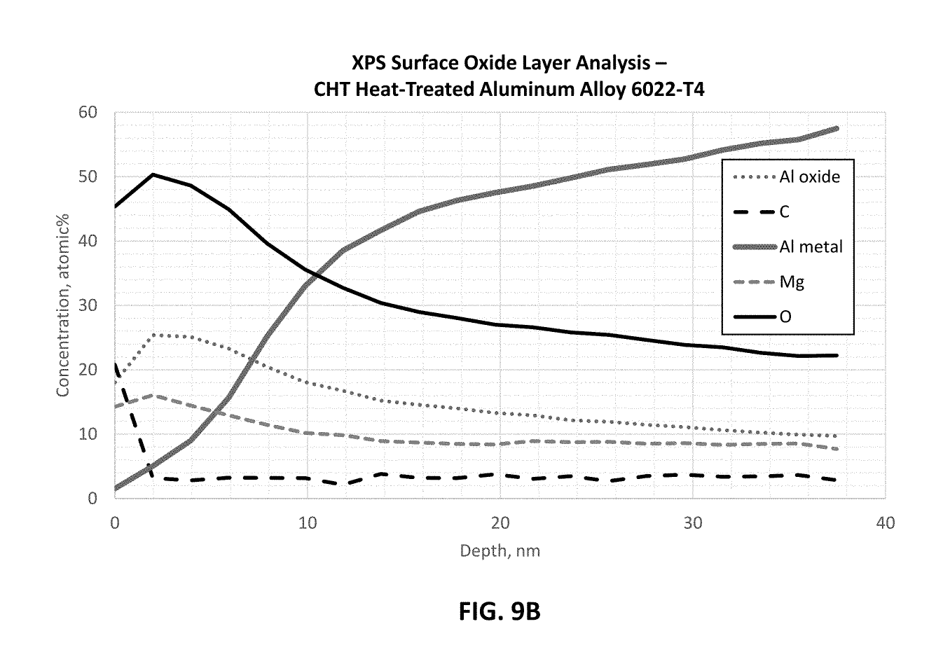

The XPS analysis is performed on the invention sample of the induction heated 6022-T4 aluminum alloy sheet product and on a sample of the CHT-heat treated 6022-T4 aluminum alloy sheet product. Prior to the XPS analysis, and with the exception of contacting the samples with the adhesive bonding agent and performing the subsequent bonding step, the CHT sample is prepared in the same manner as described above for the reference sample in Prophetic Example 3. The induction heat treated invention sample is prepared in the same manner as described above for the invention sample in Prophetic Example 3. The XPS analysis results are illustrated in FIGS. 9A and 9B.

FIG. 9A is a plot of XPS analysis results for the surface oxide layer of the above-described induction heat treated 6022-T4 aluminum alloy sheet product invention sample. FIG. 9B is a plot of XPS analysis results for the surface oxide of the above-described CHT heat treated 6022-T4 aluminum alloy sheet product sample. In each of the plots shown in FIGS. 9A and 9B, the intersection point of the oxygen and aluminum metal curves is taken as the mean thickness of the respective surface oxide layer. It is accepted in the industry that a thinner oxide of low magnesium content provides a preferred surface for good adhesive bonding response. Indeed, the 5.4 nm thick oxide created by the disclosed induction heating-based method is in many ways comparable to the thickness of the oxide of the CHT-processed metal of the same alloy after surface preparation by a combination of such techniques as hot water wash, cleaning, acid etching/deoxidization and functionalization steps. The magnesium content of the oxide at the metal surface is 12-14 atomic %, also lower than the 15-17 atomic % found in the sample treated by CHT. Without being bound to any particular theory or mechanism, the XPS data vis-à-vis the bond test indicated that this level of magnesium in the surface oxide layers has a positive effect on bond durability.

### Non-Limiting Example 5

A coil of 0.063 inch gauge 5754 aluminum alloy sheet product was uncoiled and then annealed using a transverse flux induction heater. Prior to these uncoiling and induction heating steps, the 5754 aluminum alloy sheet product was hot and warm rolled to the 0.063 inch gauge. The 5754 aluminum alloy sheet proceeded through the induction heater for a residence time of 18 seconds and the PMT on the sheet was measured as 950° F.

Upon exiting the induction heater, the induction heated 5754 aluminum alloy sheet product was quenched using deionized water at a temperature of 150° F. Next, the induction heated and quenched 5754-O aluminum alloy sheet product was contacted with an acidic solution of a deoxidizing agent at 170° F. for 6 seconds. The as-deoxidized 5754-O aluminum alloy sheet product was then coiled.

Single-lap-joint specimens of the as-deoxidized 5754-O aluminum alloy sheet product were prepared according to the procedure described above for Non-Limiting Example 2. The cyclic BDT protocol, and the initial and residual bond shear strength tests were performed according to the procedure described above for Non-Limiting Example 2. The bonds of all single-lap-joint specimens of the as-bonded 5754-O aluminum alloy sheet product had to complete 45 cycles in order to pass SDT.

For both the initial and residual bond shear strength tests, a failure mode was determined and recorded. The results obtained were compared with those from reference single-lap-joint specimens bonds made after the surface of the induction heated and quenched 5754-O aluminum alloy sheet product was prepared according to the known method described above with reference to FIG. 5. Four single-lap-joint specimens of the reference 5754-O aluminum alloy sheet product were prepared according to the procedure discussed above.

All single-lap-joint specimens of the as-bonded 5754-O aluminum alloy sheet product completed 45 cycles. The results of the initial and residual bond shear strength testing are shown in Table 5, below.

TABLE 5

| | | | | | | | Residual |
|---|---|---|---|---|---|---|---|
| | Initial Shear Strength | | | Residual Shear Strength | | | v. Initial |
| | Shear | Mean Shear | | Shear | Mean Shear | | Shear |
| | Strength | Strength | Failure | Strength | Strength | Failure | Strength |
| | (psi) | (psi) | Mode | (psi) | (psi) | Mode | (%) |
| 5754-O | 2921 | 2858 | adh | 3179 | 3068 | adh | 93.2 |
| | 2901 | | | 3072 | | | |
| | 2795 | | | 3011 | | | |
| | 2816 | | | 3011 | | | |
| Reference | 3447 | 3570 | adh | 3117 | 3307 | adh | 92.6 |
| | 3521 | | | 3313 | | | |
| | 3807 | | | 3026 | | | |
| | 3505 | | | 3771 | | | |

In Table 5, above, the failure mode indicator “adh” denotes that the bond failure was due to a complete failure of the adhesion interface between the glue and the metal surface. When compared to the initial bond shear strength, it was found that in all cases shown in Table 5, above, there was minimal loss of strength during the SDT protocol. By completing the 45 BDT cycles and showing a residual strength greater than 80% of the initial strength, these bonds tested after preparing the 5754-O aluminum alloy sheet product according to the disclosed method thus easily meet the requirements of structural adhesive bonds for auto applications in aluminum alloy 5754.

Preparation of Aluminum Alloy Products for Treatment with Functionalization Solution

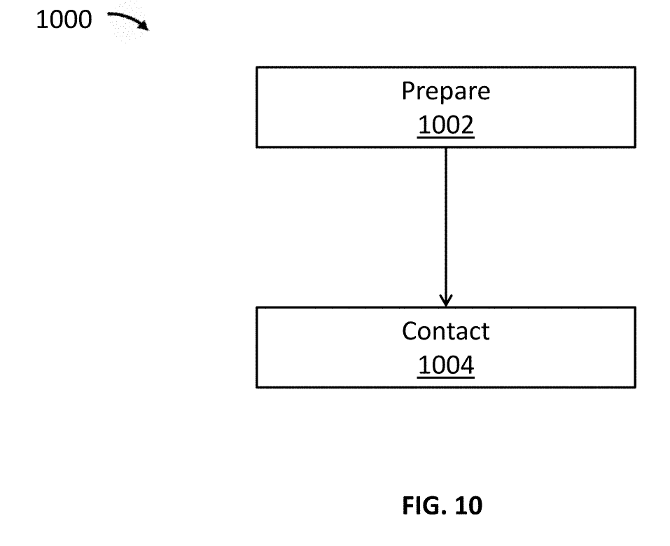

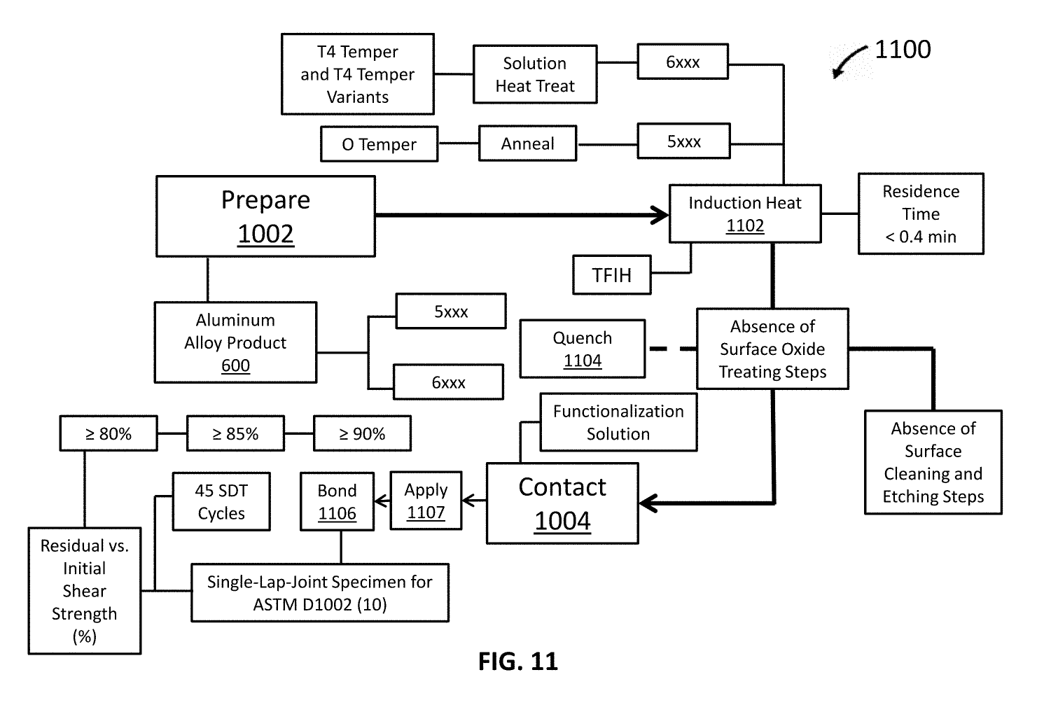

In an embodiment, and referring now to FIGS. 10 and 11, a method (1000) includes the step of preparing (1002) an aluminum alloy product (600) for treatment with a functionalization solution. In one embodiment (e.g., method (1100)), the preparing (1002) step includes induction heating (1102), with an induction heater, at least a portion of an as-received aluminum alloy product (600) feedstock.

In one embodiment, the as-received aluminum alloy product (600) feedstock is a sheet product. In one embodiment, the sheet product has a gauge of from 0.5 to 6 mm after the induction heating (1102) and an optional quenching (1104). In another embodiment, the as-received aluminum alloy product (600) feedstock is an extruded product. In yet another embodiment, the as-received aluminum alloy product (600) feedstock is a forged product. In one embodiment, the forged product is a symmetric forging. In one embodiment, the forged product is a shaped forging. In still another embodiment, the as-received aluminum alloy product (600) feedstock is a cast product. In one embodiment, the cast product is a symmetric casting. In one embodiment, the cast product is a shaped casting. In another embodiment, the as-received aluminum alloy product (600) is an additively manufactured part.

In one embodiment, the induction heater includes a transverse flux induction heater (TFIH). In one embodiment, the induction heating (1102) is performed substantially as shown as described with reference to FIGS. 1-4, above. In one embodiment, a line speed of the aluminum alloy product (600) through the induction heater during the induction heating (1102) step is from 100 to 200 feet per minute. In one embodiment, the at least a portion of the aluminum alloy product (600) realizes a residence time of not greater than 0.4 minutes of induction heating (1102). In another embodiment, the at least a portion of the aluminum alloy product (600) realizes a residence time of from 0.2 to 0.4 minutes of induction heating (1102). In one embodiment, the at least a portion of the aluminum alloy product (600) realizes a peak metal temperature of from 900 to 1040° F. during the induction heating (1102). In another embodiment, the at least a portion of the aluminum alloy product (600) realizes a peak metal temperature of from 900 to less than 1040° F. during the induction heating (1102). In yet another embodiment, the at least a portion of the aluminum alloy product (600) realizes a peak metal temperature of from 930 to 1030° F. during the induction heating (1102). In still another embodiment, the at least a portion of the aluminum alloy product (600) realizes a peak metal temperature of from 950 to 1020° F. during the induction heating (1102). In yet another embodiment, the at least a portion of the aluminum alloy product (600) realizes a peak metal temperature of from 970 to 1000° F. during the induction heating (1102).

In one embodiment, the induction heating (1102) includes annealing or solution heat treating the aluminum alloy product (600). In one embodiment, the preparing (1002) step includes quenching (1104) the induction heated aluminum alloy product (600). In another embodiment, the preparing (1002) step does not include quenching (1104) the induction heated aluminum alloy product (600). In yet another embodiment, the quenching (1104) step is optional for the preparing (1002) step.

In one embodiment, the as-received aluminum alloy product (600) is a 5xxx aluminum alloy product (600), and the induction heating (1102) step is configured to accomplish an annealing of the 5xxx aluminum alloy product (600). In one embodiment, the induction heated 5xxx aluminum alloy product (600) is in the O-temper.

In another embodiment, the as-received aluminum alloy product (600) is a 6xxx aluminum alloy product (600), and the induction heating (1102) step is configured to accomplish a solution heat treating of the 6xxx aluminum alloy product (600). In one embodiment, the induction heated 6xxx aluminum alloy product (600) is in the T4-temper. In another embodiment, the induction heated 6xxx aluminum alloy product (600) is in the T43-temper. In another embodiment, the induction heated 6xxx aluminum alloy product (600) is in the T4E32-temper.

In the embodiment, method (1000) includes a contacting (1004) step. In the embodiment, the contacting (1004) step may be performed after the preparing (1002) step. In the embodiment, the contacting (1004) step may include contacting the at least a portion of the induction heated and optionally quenched aluminum alloy product (600) with the functionalization solution. In method (1000), between the preparing (1002) and contacting (1004) steps, the method (1000) is absent of any surface oxide treating steps of the aluminum alloy product (600). In one embodiment, between the preparing (1002) and the contacting step (1004) the method (1000) is absent of any surface cleaning and etching treatments.

In one embodiment, the functionalization solution comprises a phosphorus-containing organic acid. In one embodiment, the contacting step (1004) facilitates creating a functionalized aluminum alloy product (600). In one embodiment, method (1100) may include a bonding (1106) step. In the embodiment, the bonding (1106) step may include applying (1107) an adhesive bonding agent to the at least a portion of the aluminum alloy product (600), and then bonding (1106) the at least a portion of the aluminum alloy product (600) with a second material, thereby creating an as-bonded aluminum alloy product (600). In the embodiment, the bonding (1106) step may include curing the adhesive bonding agent of the as-bonded aluminum alloy product (600) for a predetermined amount of time and/or at a predetermined temperature. In one embodiment, the at least a portion of the aluminum alloy product (600) includes a first portion of the aluminum alloy product (600), and the second material includes at least a second portion of the aluminum alloy product (600). In one embodiment, the as-bonded aluminum alloy product (600) may include the first portion of the aluminum alloy product (600) adhesively structurally bonded to the second material via the applied and/or cured adhesive bonding agent. In method (1100), between the preparing (1102) and bonding (1104) steps, the method (1100) is absent of any surface oxide treating steps of the aluminum alloy product (600).

In one embodiment of method (1000), when the as-bonded aluminum alloy product (600) is in a form of a single-lap-joint specimen having an aluminum metal-to-aluminum metal joint overlap of 0.5 inches, the as-bonded aluminum alloy product (600) achieves completion of 45 stress durability test (SDT) cycles according to ASTM D1002 (10). In one embodiment, a residual shear strength of the single-lap-joint specimen after completing the 45 SDT cycles is at least 80% of an initial shear strength of the single-lap-joint specimen prior to completing the 45 SDT cycles. In another embodiment, the residual shear strength of the single-lap-joint specimen after completing the 45 SDT cycles is at least 85% of the initial shear strength of the single-lap-joint specimen prior to completing the 45 SDT cycles. In yet another embodiment, the residual shear strength of the single-lap-joint specimen after completing the 45 SDT cycles is at least 90% of the initial shear strength of the single-lap-joint specimen prior to completing the 45 SDT cycles.

### Prophetic Example 6

A coil of 0.059 inch gauge 6022 aluminum alloy sheet product is uncoiled and then solution heat treated using a transverse flux induction heater. Prior to these uncoiling and induction heating steps, this 6022 aluminum alloy sheet product is prepared using a direct chill (DC) cast ingot rolling technique. This 6022 aluminum alloy sheet proceeds through the induction heater for a residence time of 9 seconds and the PMT on the sheet is measured as 1020° F. By contrast, the PMT of 6022-T4 aluminum alloy sheet product solution heat treated using conventional Continuous heat treatment (CHT) furnaces is typically from 1040-1060° F.

Upon exiting the induction heater, this induction heated 6022 aluminum alloy sheet product is quenched using deionized water at a temperature of 150° F. Mechanical properties of the sheet are measured after the induction heated 6022-T4 aluminum alloy sheet product reaches the T4 temper, and are found to be equivalent to or better than those obtained in CHT processed material. Next, two 6 inch×4 inch size pieces (with the 4 inch dimension being in the rolling direction) are removed from this 6022-T4 aluminum alloy sheet product coil. Each of the two pieces is washed in 150° F. deionized water for 8 seconds to remove lubricants and other contaminants from the preceding steps.

Next, four pieces of this 6022-T4 aluminum alloy sheet product are prepared according to the known method described above with reference to FIG. 5, where the acidic organophosphorus compound is maintained at 150° F. and contacts the sheet surface for 8 seconds to produce a functionalized layer on the surface of the sheet product. These four pieces are denoted as reference samples.

In accordance with one embodiment of the disclosed method, the other four pieces are prepared without the etching step of the known method of FIG. 5 (i.e., without the step of contacting the sheet surface with the acidic solution). These other four pieces are denoted as invention samples. The invention samples are contacted with a phosphorus-containing organic acid (PCOA) to create the functionalized layer, as disclosed in U.S. Pat. No. 5,463,804 and U.S. Patent Application Publication No. 2016/0319440, which are incorporated by reference herein in their entirety.

The adhesive bonding responses of single-lap-shear specimens prepared from the reference and inventive samples are evaluated in SDT by the techniques described above with reference to Non-Limiting Example 2. For both the reference and invention samples, all single-lap-joint specimens complete 45 cycles. Without being bound to any particular theory or mechanism, the results of this Prophetic Example 6 indicate that this embodiment of the disclosed method produces a surface that performs as well as or better in adhesive bonding than the metal prepared according to the known method of FIG. 5.

Preparation of Aluminum Alloy Products for Bonding

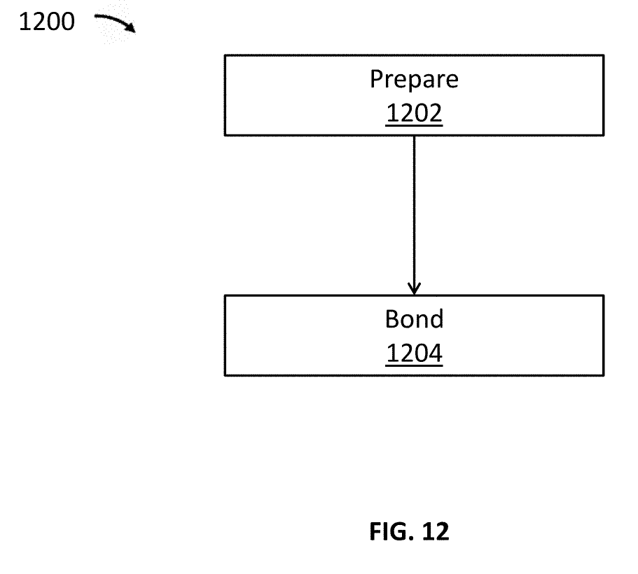

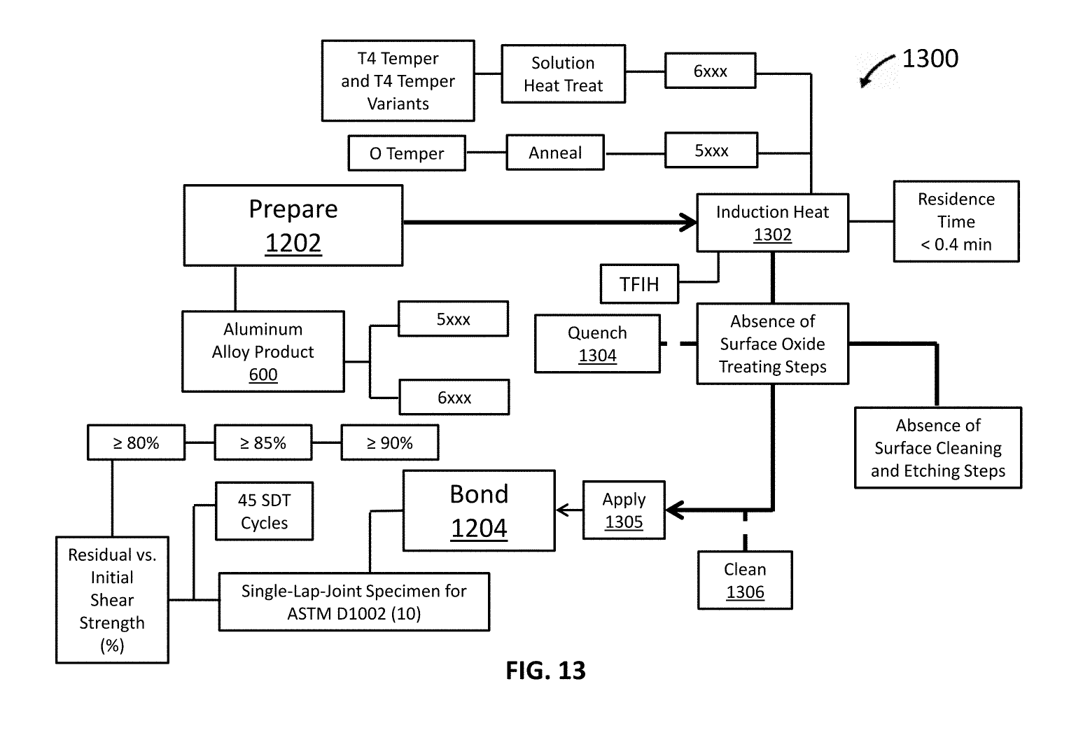

In an embodiment, and referring now to FIGS. 12 and 13, a method (1200) includes the step of preparing (1202) an aluminum alloy product (600) for bonding. In one embodiment (e.g., method (1300)), the preparing (1202) step includes induction heating (1302), with an induction heater, at least a portion of an as-received aluminum alloy product (600) feedstock.

In one embodiment, the as-received aluminum alloy product (600) feedstock is a sheet product. In one embodiment, the sheet product has a gauge of from 0.5 to 6 mm after the induction heating (1302) and an optional quenching (1304). In another embodiment, the as-received aluminum alloy product (600) feedstock is an extruded product. In yet another embodiment, the as-received aluminum alloy product (600) feedstock is a forged product. In one embodiment, the forged product is a symmetric forging. In one embodiment, the forged product is a shaped forging. In still another embodiment, the as-received aluminum alloy product (600) feedstock is a cast product. In one embodiment, the cast product is a symmetric casting. In one embodiment, the cast product is a shaped casting. In another embodiment, the as-received aluminum alloy product (600) is an additively manufactured part.

In one embodiment, the induction heater includes a transverse flux induction heater (TFIH). In one embodiment, the induction heating (1302) is performed substantially as shown as described with reference to FIGS. 1-4, above. In one embodiment, a line speed of the aluminum alloy product (600) through the induction heater during the induction heating (1302) step is from 100 to 200 feet per minute. In one embodiment, the at least a portion of the aluminum alloy product (600) realizes a residence time of not greater than 0.4 minutes of induction heating. In another embodiment, the at least a portion of the aluminum alloy product (600) realizes a residence time of from 0.2 to 0.4 minutes of induction heating. In one embodiment, the at least a portion of the aluminum alloy product (600) realizes a peak metal temperature of from 900 to 1040° F. during the induction heating (1302). In another embodiment, the at least a portion of the aluminum alloy product (600) realizes a peak metal temperature of from 900 to less than 1040° F. during the induction heating (1302). In yet another embodiment, the at least a portion of the aluminum alloy product (600) realizes a peak metal temperature of from 930 to 1030° F. during the induction heating (1302). In still another embodiment, the at least a portion of the aluminum alloy product (600) realizes a peak metal temperature of from 950 to 1020° F. during the induction heating (1302). In yet another embodiment, the at least a portion of the aluminum alloy product (600) realizes a peak metal temperature of from 970 to 1000° F. during the induction heating (1302).

In one embodiment, the induction heating (1302) includes annealing or solution heat treating the aluminum alloy product (600). In one embodiment, the preparing (1202) step includes quenching (1304) the induction heated aluminum alloy product (600). In another embodiment, the preparing (1202) step does not include quenching (1304) the induction heated aluminum alloy product (600). In yet another embodiment, the quenching (1304) step is optional for the preparing (1202) step.

In one embodiment, the as-received aluminum alloy product (600) is a 5xxx aluminum alloy product (600), and the induction heating (1302) step is configured to accomplish an annealing of the 5xxx aluminum alloy product (600). In one embodiment, the induction heated 5xxx aluminum alloy product (600) is in the O-temper.

In another embodiment, the as-received aluminum alloy product (600) is a 6xxx aluminum alloy product (600), and the induction heating (1302) step is configured to accomplish a solution heat treating of the 6xxx aluminum alloy product (600). In one embodiment, the induction heated 6xxx aluminum alloy product (600) is in the T4-temper. In another embodiment, the induction heated 6xxx aluminum alloy product (600) is in the T43-temper. In another embodiment, the induction heated 6xxx aluminum alloy product (600) is in the T4E32-temper.

In the embodiment, method (1200) includes a bonding (1204) step. In the embodiment, the bonding (1204) step may be performed after the preparing (1202) step. In one embodiment, the bonding (1204) step may include applying (1305) an adhesive bonding agent to the at least a portion of the aluminum alloy product (600), and then bonding (1204) the at least a portion of the aluminum alloy product with a second material, thereby creating an as-bonded aluminum alloy product (600). In the embodiment, the bonding (1204) step may include curing the adhesive bonding agent of the as-bonded aluminum alloy product (600) for a predetermined amount of time and/or at a predetermined temperature. In method (1200), between the preparing (1202) and bonding (1204) steps, the method (1200) is absent of any surface oxide treating steps of the aluminum alloy product (600).

In one embodiment, between the preparing (1202) and the bonding (1204) steps the method (1200) is absent of any surface cleaning and etching treatments. In one embodiment, method (1200) includes cleaning (1306) the at least a portion of the aluminum alloy product (600) between the preparing (1202) step and the bonding (1204) step.

In one embodiment, the at least a portion of the aluminum alloy product (600) includes a first portion of the aluminum alloy product (600). In the embodiment, the second material includes at least a second portion of the aluminum alloy product (600). In one embodiment, the as-bonded aluminum alloy product (600) may include the first portion of the aluminum alloy product (600) adhesively structurally bonded to the second material via the applied and/or cured adhesive bonding agent.

In one embodiment of method (1200), when the as-bonded aluminum alloy product (600) is in a form of a single-lap-joint specimen having an aluminum metal-to-aluminum metal joint overlap of 0.5 inches, the as-bonded aluminum alloy product (600) achieves completion of 45 stress durability test (SDT) cycles according to ASTM D1002 (10). In one embodiment, a residual shear strength of the single-lap-joint specimen after completing the 45 SDT cycles is at least 80% of an initial shear strength of the single-lap-joint specimen prior to completing the 45 SDT cycles. In another embodiment, the residual shear strength of the single-lap-joint specimen after completing the 45 SDT cycles is at least 85% of the initial shear strength of the single-lap-joint specimen prior to completing the 45 SDT cycles. In yet another embodiment, the residual shear strength of the single-lap-joint specimen after completing the 45 SDT cycles is at least 90% of the initial shear strength of the single-lap-joint specimen prior to completing the 45 SDT cycles.

### Non-Limiting Example 7

The adhesive bonding response of aluminum alloy products prepared for surface deoxidization according to one embodiment of the disclosed method was evaluated by stress durability tests (SDT), according to ASTM D1002 (10) and where single-lap-joint specimens had an aluminum metal-to-aluminum metal joint overlap of 0.5 inches. A coil of 0.059 inch gauge 6022 aluminum alloy sheet product was uncoiled and then solution heat treated using a transverse flux induction heater. Prior to these uncoiling and induction heating steps, the 6022 aluminum alloy sheet products were prepared using a continuous casting technique. The 6022 aluminum alloy sheets proceeded through the induction heater for a residence time of 18 seconds the peak metal temperature (PMT) on the sheets were measured as 970° F. By contrast, the PMT of 6022-T4 aluminum alloy sheet product solution heat treated using conventional Continuous heat treatment (CHT) furnaces is typically from 1040-1060° F.

Upon exiting the induction heater, the induction heated 6022 aluminum alloy sheet product was quenched using deionized water at a temperature of 150° F. Mechanical properties of the sheets were measured after the induction heated 6022-T4 aluminum alloy sheet products reached the T4 temper, and were found to be equivalent to or better than those obtained in CHT processed material.

Two 6 inch×4 inch size pieces (with the 4 inch dimension being in the rolling direction) were removed from the induction heated and quenched 6022-T4 aluminum alloy sheet product coil. Using the two pieces, four single-lap-joint specimens were prepared with a bonded joint overlap of 0.5 inches. Prior to this bonding step, and after the induction heating and quenching steps, no surface oxide treating steps were performed on any of the eight pieces.

Single-lap-joint specimens of the induction heated and quenched 6022-T4 aluminum alloy sheet product were prepared according to the procedure described above for Non-Limiting Example 2. The cyclic BDT protocol, and the initial and residual bond shear strength tests were performed according to the procedure described above for Non-Limiting Example 2. The bonds of all single-lap-joint specimens of these as-bonded 6022-T4 aluminum alloy sheet product had to complete 45 cycles in order to pass SDT.

For both the initial and residual bond shear strength tests, a failure mode was determined and recorded. The results obtained were compared with those from reference single-lap-joint specimens bonds made after the surface of the induction heated and quenched 6022-T4 aluminum alloy sheet product was prepared according to the known method described above with reference to FIG. 5. Four single-lap-joint specimens of the reference 6022-T4 aluminum alloy sheet product were prepared according to the procedure discussed above.

All single-lap-joint specimens of the as-bonded 6022-T4 aluminum alloy sheet product completed 45 cycles. The results of the initial and residual bond shear strength testing are shown in Table 6, below.

TABLE 6

| | | | | | | | Residual |
|---|---|---|---|---|---|---|---|
| | Initial Shear Strength | | | Residual Shear Strength | | | v. Initial |
| | Shear | Mean Shear | | Shear | Mean Shear | | Shear |
| | Strength | Strength | Failure | Strength | Strength | Failure | Strength |
| | (psi) | (psi) | Mode | (psi) | (psi) | Mode | (%) |
| 6022-T4 | 4174 | 4301 | most | 4217 | 4362 | adh | 100 |
| | 4559 | | adh | 4460 | | | |
| | 4229 | | | 4567 | | | |
| | 4242 | | | 4202 | | | |
| Reference | 5311 | 5102 | coh | 5252 | 5097 | coh | 99.9 |
| | 5177 | | | 5148 | | | |
| | 4991 | | | 5307 | | | |
| | 4930 | | | 4679 | | | |

In Table 6, above, the failure mode indicator “coh” denotes that the bond failure was due to failure of the bond glue. The failure mode indicator “adh” denotes that the bond failure was due to a complete failure of the adhesion interface between the glue and the metal surface. The failure mode indicator “most adh” denotes that the bond failure was due to widespread variation in the adhesion interface between the glue and the metal surface. Also, in Table 6, above, if the calculated percent (%) value for residual vs. initial bond shear strength was greater than 100%, then 100% was nevertheless indicated. When compared to the initial bond shear strength, it was found that in all cases shown in Table 6, above, there was minimal loss of strength during the SDT protocol. By completing the 45 BDT cycles and showing a residual strength greater than 80% of the initial strength, these bonds tested after preparing the 6022-T4 aluminum alloy sheet product according to the disclosed method thus easily meet the requirements of structural adhesive bonds for auto applications in aluminum alloy 6022.

### Non-Limiting Example 8

A coil of 0.063 inch gauge 5754 aluminum alloy sheet product was uncoiled and then annealed using a transverse flux induction heater. Prior to these uncoiling and induction heating steps, the 5754 aluminum alloy sheet product was hot and warm rolled to the 0.063 inch gauge. The 5754 aluminum alloy sheet proceeded through the induction heater with a residence time of 18 seconds and the PMT on the sheet was measured as 950° F.

Upon exiting the induction heater, the induction heated 5754 aluminum alloy sheet product was quenched using deionized water at a temperature of 150° F. and was coiled. Next, samples from the induction heated and quenched 5754-O aluminum alloy sheet product were contacted with an acidic solution of a deoxidizing agent at 170° F. for 6 seconds. The induction heated and quenched 5754-O aluminum alloy sheet product was then coiled.

Single-lap-joint specimens of the 5754-O aluminum alloy sheet product were prepared according to the procedure described above for Non-Limiting Example 2. The cyclic BDT protocol, and the initial and residual bond shear strength tests were performed according to the procedure described above for Non-Limiting Example 2. The bonds of all single-lap-joint specimens of the as-bonded 5754-O aluminum alloy sheet product had to complete 45 cycles in order to pass SDT.

For both the initial and residual bond shear strength tests, a failure mode was determined and recorded. The results obtained were compared with those from reference single-lap-joint specimens bonds made after the surface of the induction heated and quenched 5754-O aluminum alloy sheet product was prepared according to the known method described above with reference to FIG. 5. Four single-lap-joint specimens of the reference 5754-O aluminum alloy sheet product were prepared according to the procedure discussed above.

All single-lap-joint specimens of the as-bonded 5754-O aluminum alloy sheet product completed 45 cycles. The results of the initial and residual bond shear strength testing are shown in Table 7, below.

TABLE 7

| | | | | | | | Residual |
|---|---|---|---|---|---|---|---|
| | Initial Shear Strength | | | Residual Shear Strength | | | v. Initial |
| | Shear | Mean Shear | | Shear | Mean Shear | | Shear |
| | Strength | Strength | Failure | Strength | Strength | Failure | Strength |
| | (psi) | (psi) | Mode | (psi) | (psi) | Mode | (%) |
| 5754-O | N/A* | | | 3503 | 3298 | adh | N/A* |
| | | | | 3374 | | | |
| | | | | 3217 | | | |
| | | | | 3098 | | | |
| Reference | 3447 | 3570 | adh | 3117 | 3307 | adh | 92.6 |
| | 3521 | | | 3313 | | | |
| | 3807 | | | 3026 | | | |
| | 3505 | | | 3771 | | | |

*For this 5754-O sample, the four single-lap-joint specimens were not tested for initial bond shear strength.

In Table 7, above, the failure mode indicator “adh” denotes that the bond failure was due to a complete failure of the adhesion interface between the glue and the metal surface. By completing the 45 BDT cycles and showing a residual strength within 0.3% of the residual strength of the reference specimens, these bonds tested after preparing the 5754-O aluminum alloy sheet product according to the disclosed method thus easily meet the requirements of structural adhesive bonds for auto applications in aluminum alloy 5754.

In the practice of the disclosed methods at induction heating residence times less than 0.4 min for the induction heating step, the metal experiences a fast heat up, but the metal spends less time heating up as compared to CHT-based techniques. Induction heating is an internal heating (i.e., from the inside out), rather than an outside-in heating, as for CHT. As one example, for an induction heating line the metal heats up to 900° F. in 0.4 minutes. As another example, for an induction heating line the metal heats up to 900° F. in 0.2 minutes. The initial temperature of the metal, line speed, residence time, heating duration, and other operational parameters of the induction heater may be adjusted and controlled to achieve the desired heating rate and the desired PMT achieved in the metal during the induction heating step.

The induction heating step provides for attaining the desired PMT in the metal during the induction heating step more quickly as compared to CHT, and with the same or better subsequent bonding performance as compared to CHT and to the known method shown and described above with reference to FIG. 5. Without being bound to any particular theory or mechanism, it is believed that, on account of the inside-out heating nature of induction heating and/or decreased oxygen present in the induction heater as compared to CHT furnaces, surface oxide does not have sufficient time to grow on the surface of the metal. With longer residence times employed during the induction heating step, however, surface oxide may be observed to grow on the surface of the metal, as it is known to do for at least some CHT-based heating processes. Therefore, additional surface treatments such as cleaning and/or etching the metal surface to reduce the amount and thickness of surface oxide are not necessary in the methods disclosed herein. As such, use of the disclosed methods provides improved efficiencies including, without limitation, in terms of costs, times, and material, as compared to known methods (e.g., U.S. Patent Publication No. 2016/0319440).

Aspects of the invention will now be described with reference to the following numbered clauses:

1. A method comprising the step of (a) preparing an aluminum alloy product for surface deoxidization, wherein the preparing step (a) comprises: (i) induction heating at least a portion of the aluminum alloy product; and (ii) optionally quenching the induction heated aluminum alloy product. The method comprises the step of contacting (b), after the preparing step (a), the at least a portion of the aluminum alloy product with a deoxidizing agent, wherein between the preparing step (a) and the contacting step (b) the method is absent of any surface oxide treating steps of the aluminum alloy product.
2. The method of clause 1, wherein the induction heating comprises annealing or solution heat treating the aluminum alloy product.
3. The method of any preceding clause, wherein between the preparing step (a) and the contacting step (b) the method is absent of any surface cleaning and etching treatments.
4. The method of any preceding clause, wherein after the contacting step (b) the method is absent of any surface cleaning and etching treatments.
5. The method of any preceding clause further comprising cleaning the at least a portion of the aluminum alloy product between the preparing step (a) and the contacting step (b).
6. The method of any preceding clause comprising bonding the at least a portion of the aluminum alloy product with a second material after the contacting step (b), thereby creating an as-bonded aluminum alloy product.
7. The method of any preceding clause, wherein: (i) the at least a portion of the aluminum alloy product includes a first portion of the aluminum alloy product; (ii) the second material includes at least a second portion of the aluminum alloy product; and (iii) when in a form of a single-lap-joint specimen having an aluminum metal-to-aluminum metal joint overlap of 0.5 inches, the as-bonded aluminum alloy product achieves completion of 45 stress durability test (SDT) cycles according to ASTM D1002 (10).
8. The method of any preceding clause, wherein a residual shear strength of the single-lap-joint specimen after completing the 45 SDT cycles is at least 80% of an initial shear strength of the single-lap-joint specimen prior to commencing the 45 SDT cycles.
9. The method of any preceding clause, wherein the residual shear strength of the single-lap-joint specimen after completing the 45 SDT cycles is at least 85% of the initial shear strength of the single-lap-joint specimen prior to commencing the 45 SDT cycles.
10. The method of any preceding clause, wherein the residual shear strength of the single-lap-joint specimen after completing the 45 SDT cycles is at least 90% of the initial shear strength of the single-lap-joint specimen prior to commencing the 45 SDT cycles.
11. The method of any preceding clause, wherein the aluminum alloy product is a 5xxx aluminum alloy product.
12. The method of any preceding clause, wherein the inducting heating comprises providing an O-tempered 5xxx aluminum alloy product.
13. The method of any preceding clause, wherein the aluminum alloy product is a 6xxx aluminum alloy product.
14. The method of any preceding clause, wherein the inducting heating comprises providing a T4-tempered 6xxx aluminum alloy product.
15. The method of any preceding clause, wherein the at least a portion of the aluminum alloy product realizes a residence time of not greater than 0.4 minutes in the induction heater.
16. The method of any preceding clause, wherein the at least a portion of the aluminum alloy product realizes a residence time of from 0.2 to 0.4 minutes in the induction heater.
17. The method of any preceding clause, wherein the at least a portion of the aluminum alloy product realizes a peak metal temperature of from 900 to 1040° F.
18. The method of any preceding clause, wherein the at least a portion of the aluminum alloy product realizes a peak metal temperature of from 900 to less than 1040° F.
19. The method of any preceding clause, wherein the at least a portion of the aluminum alloy product realizes a peak metal temperature of from 930 to 1030° F.
20. The method of any preceding clause, wherein the at least a portion of the aluminum alloy product realizes a peak metal temperature of from 950 to 1020° F.
21. The method of any preceding clause, wherein the at least a portion of the aluminum alloy product realizes a peak metal temperature of from 970 to 1000° F.
22. The method of any preceding clause, wherein the aluminum alloy product is a sheet product.
23. The method of any preceding clause, wherein the sheet product has a gauge of from 0.5 to 6 mm after the induction heating and the optional quenching.
24. The method of any preceding clause, wherein the aluminum alloy product is an extruded product.
25. The method of any preceding clause, wherein the aluminum alloy product is a forged product.
26. The method of any preceding clause, wherein the forged product is a symmetric forging.
27. The method of any preceding clause, wherein the forged product is a shaped forging.
28. The method of any preceding clause, wherein the aluminum alloy product is a cast product.
29. The method of any preceding clause, wherein the cast product is a symmetric casting.
30. The method of any preceding clause, wherein the cast product is a shaped casting.
31. The method of any preceding clause, wherein the aluminum alloy product is an additively manufactured part.
32. A method comprising the step of (a) preparing an aluminum alloy product for treatment with a functionalization solution, wherein the preparing step (a) comprises (i) induction heating at least a portion of the aluminum alloy product; and (ii) optionally quenching the induction heated aluminum alloy product. The method comprises the step of (b) contacting, after the preparing step (a), the at least a portion of the aluminum alloy product with the functionalization solution, wherein between the preparing step (a) and the contacting step (b) the method is absent of any surface oxide treating steps of the aluminum alloy product.
33. The method of clause 32, wherein the induction heating comprises annealing or solution heat treating the aluminum alloy product.
34. The method of any preceding clause, wherein between the preparing step (a) and the contacting step (b) the method is absent of any surface cleaning and etching treatments.
35. The method of any preceding clause, wherein the functionalization solution comprises a phosphorus-containing organic acid.
36. The method of any preceding clause, wherein the contacting step (b) facilitates creating a functionalized aluminum alloy product, and wherein the method comprises bonding at least a portion of the as-functionalized aluminum alloy product with a second material after the contacting step (b), thereby creating an as-bonded aluminum alloy product.
37. The method of any preceding clause, wherein: (i) the at least a portion of the aluminum alloy product includes a first portion of the aluminum alloy product; (ii) the second material includes at least a second portion of the aluminum alloy product; and (iii) when in a form of a single-lap-joint specimen having an aluminum metal-to-aluminum metal joint overlap of 0.5 inches, the as-bonded aluminum alloy product achieves completion of 45 stress durability test (SDT) cycles according to ASTM D1002 (10).
38. The method of any preceding clause, wherein a residual shear strength of the single-lap-joint specimen after completing the 45 SDT cycles is at least 80% of an initial shear strength of the single-lap-joint specimen prior to completing the 45 SDT cycles.
39. The method of any preceding clause, wherein the residual shear strength of the single-lap-joint specimen after completing the 45 SDT cycles is at least 85% of the initial shear strength of the single-lap-joint specimen prior to completing the 45 SDT cycles.
40. The method of any preceding clause, wherein the residual shear strength of the single-lap-joint specimen after completing the 45 SDT cycles is at least 90% of the initial shear strength of the single-lap-joint specimen prior to completing the 45 SDT cycles.
41. The method of any preceding clause, wherein the aluminum alloy product is a 5xxx aluminum alloy product.
42. The method of any preceding clause, wherein the inducting heating comprises providing an O-tempered 5xxx aluminum alloy product.
43. The method of any preceding clause, wherein the aluminum alloy product is a 6xxx aluminum alloy product.
44. The method of any preceding clause, wherein the inducting heating comprises providing a T4-tempered 6xxx aluminum alloy product.
45. The method of any preceding clause, wherein the at least a portion of the aluminum alloy product realizes a residence time of not greater than 0.4 minutes in the induction heater.
46. The method of any preceding clause, wherein the at least a portion of the aluminum alloy product realizes a residence time of from 0.2 to 0.4 minutes in the induction heater.
47. The method of any preceding clause, wherein the at least a portion of the aluminum alloy product realizes a peak metal temperature of from 900 to 1040° F.
48. The method of any preceding clause, wherein the at least a portion of the aluminum alloy product realizes a peak metal temperature of from 900 to less than 1040° F.
49. The method of any preceding clause, wherein the at least a portion of the aluminum alloy product realizes a peak metal temperature of from 930 to 1030° F.
50. The method of any preceding clause, wherein the at least a portion of the aluminum alloy product realizes a peak metal temperature of from 950 to 1020° F.
51. The method of any preceding clause, wherein the at least a portion of the aluminum alloy product realizes a peak metal temperature of from 970 to 1000° F.
52. The method of any preceding clause, wherein the aluminum alloy product is a sheet product.
53. The method of any preceding clause, wherein the sheet product has a gauge of from 0.5 to 6 mm after the induction heating and the optional quenching.
54. The method of any preceding clause, wherein the aluminum alloy product is an extruded product.
55. The method of any preceding clause, wherein the aluminum alloy product is a forged product.
56. The method of any preceding clause, wherein the forged product is a symmetric forging.
57. The method of any preceding clause, wherein the forged product is a shaped forging.
58. The method of any preceding clause, wherein the aluminum alloy product is a cast product.
59. The method of any preceding clause, wherein the cast product is a symmetric casting.
60. The method of any preceding clause, wherein the cast product is a shaped casting.
61. The method of any preceding clause, wherein the aluminum alloy product is an additively manufactured part.
62. A method comprising the step of (a) preparing an aluminum alloy product for bonding, wherein the preparing step (a) comprises: (i) induction heating at least a portion of the aluminum alloy product; and (ii) optionally quenching the induction heated aluminum alloy product. The method comprises the step of (b) bonding the at least a portion of the aluminum alloy product with a second material after the preparing step (a), thereby creating an as-bonded aluminum alloy product, wherein between the preparing step (a) and the bonding step (b) the method is absent of any surface oxide treating steps of the aluminum alloy product.
63. The method of clause 62, wherein the induction heating comprises annealing or solution heat treating the aluminum alloy product.
64. The method of any preceding clause, wherein after the preparing step (a) the method is absent of any surface cleaning and etching treatments.
65. The method of any preceding clause further comprising cleaning the at least a portion of the aluminum alloy product after the preparing step (a).
66. The method of any preceding clause, wherein: (i) the at least a portion of the aluminum alloy product includes a first portion of the aluminum alloy product; (ii) the second material includes at least a second portion of the aluminum alloy product; and (iii) when in a form of a single-lap-joint specimen having an aluminum metal-to-aluminum metal joint overlap of 0.5 inches, the as-bonded aluminum alloy product achieves completion of 45 stress durability test (SDT) cycles according to ASTM D1002 (10).
67. The method of any preceding clause, wherein a residual shear strength of the single-lap-joint specimen after completing the 45 SDT cycles is at least 80% of an initial shear strength of the single-lap-joint specimen prior to completing the 45 SDT cycles.
68. The method of any preceding clause, wherein the residual shear strength of the single-lap-joint specimen after completing the 45 SDT cycles is at least 85% of the initial shear strength of the single-lap-joint specimen prior to completing the 45 SDT cycles.
69. The method of any preceding clause, wherein the residual shear strength of the single-lap-joint specimen after completing the 45 SDT cycles is at least 90% of the initial shear strength of the single-lap-joint specimen prior to completing the 45 SDT cycles.
70. The method of any preceding clause, wherein the aluminum alloy product is a 5xxx aluminum alloy product.
71. The method of any preceding clause, wherein the inducting heating comprises providing an O-tempered 5xxx aluminum alloy product.
72. The method of any preceding clause, wherein the aluminum alloy product is a 6xxx aluminum alloy product.
73. The method of any preceding clause, wherein the inducting heating comprises providing a T4-tempered 6xxx aluminum alloy product.
74. The method of any preceding clause, wherein the at least a portion of the aluminum alloy product realizes a residence time of not greater than 0.4 minutes in the induction heater.
75. The method of any preceding clause, wherein the at least a portion of the aluminum alloy product realizes a residence time of from 0.2 to 0.4 minutes in the induction heater.
76. The method of any preceding clause, wherein the at least a portion of the aluminum alloy product realizes a peak metal temperature of from 900 to 1040° F.
77. The method of any preceding clause, wherein the at least a portion of the aluminum alloy product realizes a peak metal temperature of from 900 to less than 1040° F.
78. The method of any preceding clause, wherein the at least a portion of the aluminum alloy product realizes a peak metal temperature of from 930 to 1030° F.
79. The method of any preceding clause, wherein the at least a portion of the aluminum alloy product realizes a peak metal temperature of from 950 to 1020° F.
80. The method of any preceding clause, wherein the at least a portion of the aluminum alloy product realizes a peak metal temperature of from 970 to 1000° F.
81. The method of any preceding clause, wherein the aluminum alloy product is a sheet product.
82. The method of any preceding clause, wherein the sheet product has a gauge of from 0.5 to 6 mm after the induction heating and the optional quenching.
83. The method of any preceding clause, wherein the aluminum alloy product is an extruded product.
84. The method of any preceding clause, wherein the aluminum alloy product is a forged product.
85. The method of any preceding clause, wherein the forged product is a symmetric forging.
86. The method of any preceding clause, wherein the forged product is a shaped forging.
87. The method of any preceding clause, wherein the aluminum alloy product is a cast product.
88. The method of any preceding clause, wherein the cast product is a symmetric casting.
89. The method of any preceding clause, wherein the cast product is a shaped casting.
90. The method of any preceding clause, wherein the aluminum alloy product is an additively manufactured part.

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated).

What is claimed is:

1. A method comprising:
(a) preparing an aluminum alloy product for surface deoxidization, wherein the preparing step (a) comprises:
(i) induction heating at least a portion of the aluminum alloy product; and
(ii) optionally quenching the induction heated aluminum alloy product; and
(b) after the preparing step (a), contacting the at least a portion of the aluminum alloy product with a deoxidizing agent,
wherein between the preparing step (a) and the contacting step (b) the method is absent of any surface oxide treating steps of the aluminum alloy product.

2. The method of claim 1, wherein the induction heating comprises annealing or solution heat treating the aluminum alloy product.

3. The method of claim 1, wherein between the preparing step (a) and the contacting step (b) the method is absent of any surface cleaning and etching treatments.

4. The method of claim 1, wherein after the contacting step (b) the method is absent of any surface cleaning and etching treatments.

5. The method of claim 1 further comprising cleaning the at least a portion of the aluminum alloy product between the preparing step (a) and the contacting step (b).

6. The method of claim 1 comprising bonding the at least a portion of the aluminum alloy product with a second material after the contacting step (b), thereby creating an as-bonded aluminum alloy product.

7. The method of claim 6, wherein:
(i) the at least a portion of the aluminum alloy product includes a first portion of the aluminum alloy product;
(ii) the second material includes at least a second portion of the aluminum alloy product; and
(iii) when in a form of a single-lap-joint specimen having an aluminum metal-to-aluminum metal joint overlap of 0.5 inches, the as-bonded aluminum alloy product achieves completion of 45 stress durability test (SDT) cycles according to ASTM D1002 (10).

8. The method of claim 7, wherein a residual shear strength of the single-lap-joint specimen after completing the 45 SDT cycles is at least 80% of an initial shear strength of the single-lap-joint specimen prior to commencing the 45 SDT cycles.

9. The method of claim 8, wherein the residual shear strength of the single-lap-joint specimen after completing the 45 SDT cycles is at least 85% of the initial shear strength of the single-lap-joint specimen prior to commencing the 45 SDT cycles.

10. The method of claim 9, wherein the residual shear strength of the single-lap-joint specimen after completing the 45 SDT cycles is at least 90% of the initial shear strength of the single-lap-joint specimen prior to commencing the 45 SDT cycles.

11. A method comprising:
(a) preparing an aluminum alloy product for treatment with a functionalization solution, wherein the preparing step (a) comprises:
(i) induction heating at least a portion of the aluminum alloy product; and
(ii) optionally quenching the induction heated aluminum alloy product; and
(b) after the preparing step (a), contacting the at least a portion of the aluminum alloy product with the functionalization solution,
wherein between the preparing step (a) and the contacting step (b) the method is absent of any surface oxide treating steps of the aluminum alloy product.

12. The method of claim 11, wherein the induction heating comprises annealing or solution heat treating the aluminum alloy product.

13. The method of claim 11, wherein between the preparing step (a) and the contacting step (b) the method is absent of any surface cleaning and etching treatments.

14. The method of claim 11, wherein the functionalization solution comprises a phosphorus-containing organic acid.

15. The method of claim 11, wherein the contacting step (b) facilitates creating a functionalized aluminum alloy product, and wherein the method comprises bonding at least a portion of the as-functionalized aluminum alloy product with a second material after the contacting step (b), thereby creating an as-bonded aluminum alloy product.

16. The method of claim 15, wherein:
(i) the at least a portion of the aluminum alloy product includes a first portion of the aluminum alloy product;
(ii) the second material includes at least a second portion of the aluminum alloy product; and
(iii) when in a form of a single-lap-joint specimen having an aluminum metal-to-aluminum metal joint overlap of 0.5 inches, the as-bonded aluminum alloy product achieves completion of 45 stress durability test (SDT) cycles according to ASTM D1002 (10).

17. The method of claim 16, wherein a residual shear strength of the single-lap-joint specimen after completing the 45 SDT cycles is at least 80% of an initial shear strength of the single-lap-joint specimen prior to completing the 45 SDT cycles.

18. The method of claim 17, wherein the residual shear strength of the single-lap-joint specimen after completing the 45 SDT cycles is at least 85% of the initial shear strength of the single-lap-joint specimen prior to completing the 45 SDT cycles.

19. The method of claim 18, wherein the residual shear strength of the single-lap-joint specimen after completing the 45 SDT cycles is at least 90% of the initial shear strength of the single-lap-joint specimen prior to completing the 45 SDT cycles.
